(19) United States
(12) Patent Application Publication
(10) Pub. No.: US 2016/0054840 A1
(43) Pub. Date: Feb. 25, 2016

(54) TOUCH SENSOR WITH FRONT PANEL

(71) Applicant: Senseg Ltd., Espoo (FI)

(72) Inventors: Takashi Shibuya, Tokyo (JP); Kensuke Fujii, Tokyo (JP); Kouji Satou, Tokyo (JP)

(21) Appl. No.: 14/836,768

(22) Filed: Aug. 26, 2015

Related U.S. Application Data
(63) Continuation of application No. 13/721,478, filed on Dec. 20, 2012, now abandoned.

(30) Foreign Application Priority Data
Dec. 26, 2011 (JP) 2011-283808

(51) Int. Cl. G06F 3/041; G06F 3/045; G06F 1/16; G06F 3/0488; G06F 3/044; G06F 3/01

(52) U.S. Cl. CPC G06F 3/0412; G06F 3/044; G06F 3/016; G06F 1/1643; G06F 3/04883; G06F 3/045; G06F 2203/04112; G06F 2203/04808

(57) ABSTRACT

A front panel for a touch sensor, which comprises a transparent substrate, and a high resistance layer and an insulating layer having electrical insulating properties stacked in this order on the transparent substrate, wherein the surface resistivity of the high resistance layer is from 1 to 100 MΩ/□, and the luminous transmittance of the front plate for a touch sensor is at least 80%.

### BACKGROUND OF INVENTION

1. Field of Invention

The present invention relates to a front panel for a touch sensor to be provided in front of a touch panel display device provided with a so-called touch sensor to feed back the sense of touch to the fingertip of a user.

2. Discussion of Background

In recent years, a touch panel display device (interface device) provided with a touch panel display operated by directly touching a touch panel by fingers or the like has been used as an input device or an input/output device.

A touch panel display device used as an input device or an input/output device is advantageous in that an input screen can be freely constituted by use of software, and it therefore has a flexibility which can not be obtained with an input device constituted by use of mechanical switches, and in addition, it can be constituted to be light in weight and compact in form, and is low in frequency of occurrence of mechanical failures. Due to these advantageous, at present, touch panel display devices are widely used ranging from operation panels for relatively large machines to input/output devices for very small portable apparatus.

Many of touch panel display devices are so designed that the user's fingertip operating the touch panel display device only touches a flat and smooth panel surface. Therefore, the touch panel display devices do not give a click feeling such as those sensed by a fingertip operating an input device constituted by use of mechanical switches. This has been the cause of the indefinite feeling in operating a touch panel display device. To solve this problem, a touch panel display device provided with a so-called touch sensor, in which the sense of touch is fed back to the user's fingertip operating the touch panel display has been proposed (for example, Patent Document 1). The touch panel display device is so configured that a touch panel touched by the user's fingertip is vibrated, whereby the sense of touch is generated for the user.

In addition to one so designed that the sense of touch is fed back by the mechanical stimulation, a technique to give the sense of touch for the user by an electrical sense by controlling the electric charge of a protective film or the like (hereinafter referred to as a front panel) to be provided in front of a touch panel has been known (for example, Patent Document 2). In Patent Document 2, to conducting electrodes each provided with an insulator, a predetermined electrical input is applied from a voltage source to form electrostatic force (capacitive coupling) in a region between the conducting electrodes and the body, whereby an electrical sense is generated.

As such a constitution, for example, Non-Patent Document 1 discloses a touch panel having a transparent electrode stacked on a glass substrate, covered with an insulating layer.

A device as disclosed in Patent Document 2 or Non-Patent Document 1 is specifically, as shown in FIG. 1, so constituted that the voltage and the frequency are controlled in a pattern capable of reproducing the tactile feeling to be expressed, and electricity is applied to a transparent electrode (not shown) on a touch panel main body 100 from a control part not shown, and the electric charge induced on a front panel 101 side is accumulated on a layer 103 formed on a transparent substrate 102, so that the front panel 101 will be charged. When a sensory receptor X such as a finger is contacted to the surface of the front panel 101 in such a charged state, a weak electrostatic force works between them by means of an insulating layer 104, which is perceived by the sensory receptor X as the tactile feeling such as a concave-convex touch feeling.

As a front panel to be provided on such a touch panel display device provided with a so-called touch sensor, one which will not inhibit the operation of the transparent substrate provided on the touch panel main body, which accurately develops the charged state based on the voltage or the frequency fed from the control unit, and which can develop the desired sense of touch with good reproducibility, has been desired, and it has been desired to control the resistivity of the layer 103 on which the electric charge is to be accumulated precisely within a predetermined range.

On the other hand, the front panel is required to have a high light transmittance and a low reflectance to light in the visible range in order to secure the visibility, as it is provided in front of the touch panel main body which shows images. Further, the front panel of the touch panel is required to have a hardness which can withstand a certain level of pressing force and have a moderate smoothness, since it is operated by being pressed or rubbed directly by fingers or the like.

However, a front panel to be provided on such a touch panel, which excellently develops the sense of touch, which has a favorable light transmittance and a low reflectance to light in the visible region, and which has sufficient hardness and smoothness as well, has not yet been obtained, and accordingly no accurate sensor precision can be obtained, or the visibility or the operability is poor.

### PRIOR ART DOCUMENTS

### Patent Documents

Patent Document 1: JP-A-2003-288158

Patent Document 2: JP-A-2009-87359

### Non-Patent Document

Non-Patent Document 1:

http://www.disneyresearch.com/research/projects/teslatouchuist2010.pdf

### SUMMARY OF INVENTION

The present invention has been made to solve the above problems, and its object is to provide a front panel for a touch sensor which has a favorable sensor accuracy perceived by the sense of touch, which has a high light transmittance and a low reflectance to light in the visible region, and which is excellent in the visibility and the operability.

The front panel for a touch sensor of the present invention is a front panel for a touch sensor, which comprises a transparent substrate, and a high resistance layer and an insulating layer having electrical insulating properties stacked in this order on the transparent substrate, wherein the surface resistivity of the high resistance layer is from 1 to 100 MΩ/□, and the luminous transmittance of the front plate for a touch sensor is at least 85%.

The front panel for a touch sensor is preferably such that the static friction coefficient is at most 0.2. Further, it is preferred that a barrier layer is interposed between the transparent substrate and the high resistance layer. Further, the front panel for a touch sensor is preferably such that the water contact angle is at least 80°. Further, the front panel for a touch sensor is preferably such that the luminous reflectance is at most 2%.

The front panel for a touch sensor of the present invention, which comprises a transparent substrate, and a high resistance layer and an insulating layer stacked in this order on the transparent substrate, by the surface resistivity of the high resistance layer being from 1 to 100 MΩ/□, and the luminous transmittance of the front panel for a touch sensor being at least 85%, has a favorable sensor accuracy perceived by the sense of touch and is excellent in the visibility and the operability.

### BRIEF DESCRIPTION OF DRAWINGS

FIG. 1 is a view schematically illustrating a state where a fingertip is close to the surface of a touch panel provided with a front panel for a touch sensor.

FIG. 2 is a cross sectional view schematically illustrating one example of a front panel for a touch sensor of the present invention.

FIG. 3 is a cross sectional view schematically illustrating a state where the front panel for a touch sensor shown in FIG. 1 is stacked above a touch panel main body.

FIG. 4 is a cross sectional view schematically illustrating one example of a front panel for a touch sensor of the present invention.

FIG. 5 is a cross sectional view schematically illustrating one example of a front panel for a touch sensor of the present invention.

### DETAILED DESCRIPTION OF PREFERRED EMBODIMENTS

Now, embodiments of the front panel for a touch sensor of the present invention will be described.

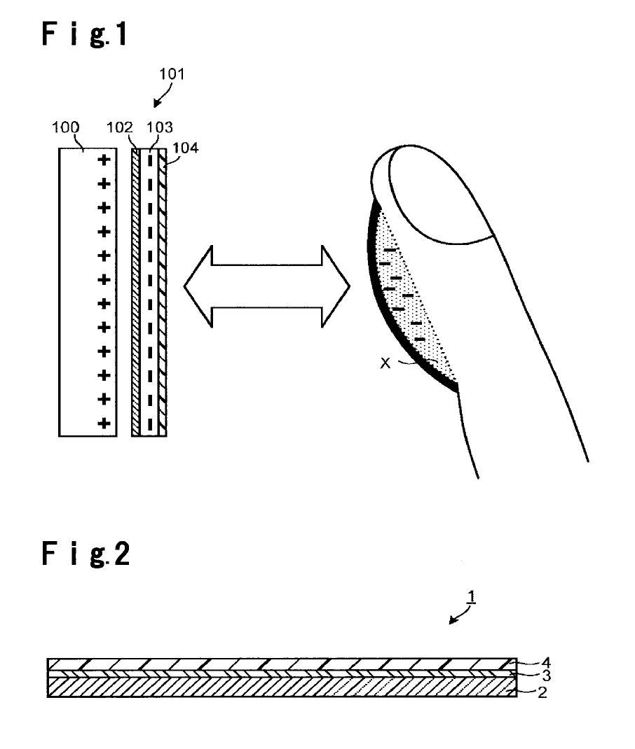

FIG. 2 is a cross sectional view schematically illustrating one example of a front panel for a touch sensor.

A front panel 1 for a touch sensor comprises a transparent substrate 2, and a high resistance layer 3 and an insulating layer 4 stacked in this order on the transparent substrate 2.

The transparent substrate 2 is not particularly limited so long as it is smooth and is transparent to light in the visible region.

Specifically, it may, for example, be a transparent glass plate made of glass such as transparent and colorless soda lime silicate glass, aluminosilicate glass (SiO₂—Al₂O₃—Na₂O type glass), lithium aluminosilicate glass, quartz glass or alkali-free glass, a plastic film consisting of a single layer of a plastic material selected from polyethylene terephthalate, polycarbonate, triacetyl cellulose, polyether sulfone, polymethyl methacrylate, a cycloolefin polymer and the like, or a plastic film such as a laminate film comprising two or more layers of the above plastic materials laminated.

The transparent substrate 2 is preferably a soda lime silicate glass plate from the viewpoint of the adhesion to a layer to be provided thereon. Further, it is preferably a tempered glass plate obtained by tempering an aluminosilicate glass plate (for example, “Dragontrail (registered trademark)”), in view of the strength of the transparent substrate 2 itself.

Considering the use pattern of the front panel 1 for a touch sensor, the transparent substrate 2 is preferably a tempered glass plate obtained by tempering an aluminosilicate glass plate, as it is required to have a sufficient strength to withstand a certain level of pressing force.

The glass material constituting the aluminosilicate glass plate may, for example, be a glass material having a composition comprising, as represented by mol %, from 50 to 80% of SiO₂, from 1 to 20% of Al₂O₃, from 6 to 20% of Na₂O, from 0 to 11% of K₂O, from 0 to 15% of MgO, from 0 to 6% of CaO and from 0 to 5% of ZrO₂.

On the surface of a tempered glass plate obtained by tempering an aluminosilicate glass, a compressive stress layer is formed, and the thickness of the compressive stress layer is preferably at least 10 μm, more preferably at least 30 μm. Further, the surface compressive stress of the compressive stress layer is preferably at least 200 MPa, more preferably at least 550 MPa.

The method of applying a chemical tempering treatment to an aluminosilicate glass plate may be typically a method of immersing an aluminosilicate glass plate in a KNO₃ molten salt to carry out ion exchange treatment, and then cooling it to the vicinity of room temperature. Treatment conditions such as the temperature of the KNO₃ molten salt and the immersion time are set so that desired surface compressive stress and thickness of the compressive stress layer are obtained.

The thickness of the transparent substrate 2 is not particularly limited, and is preferably from 0.1 to 2.0 mm, more preferably from 0.3 to 1 mm, in a case where the transparent substrate 2 is constituted by the above-described glass substrate. When the thickness of the transparent substrate 2 is at most 2 mm, the pressing force applied to the surface of the front panel 1 for a touch sensor will easily be transmitted to the panel main body located below the front panel, thus leading to favorable operability. In a case where the transparent substrate 2 is constituted by the above-described plastic film, its thickness is preferably from 50 to 500 μm, more preferably from 50 to 200 μm.

The transparent substrate 2 may be constituted by a single layer or may be constituted by a plurality of layers.

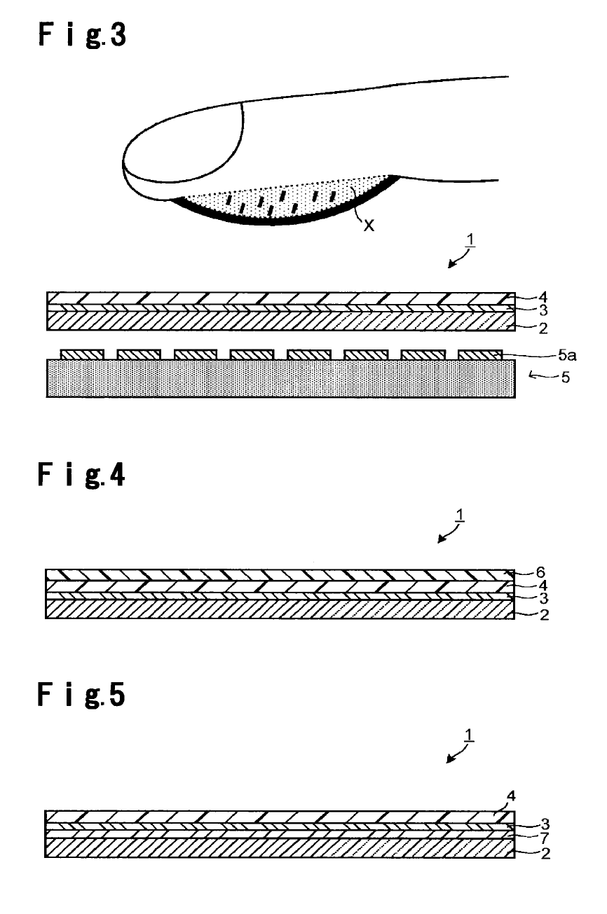

The high resistance layer 3 is a layer having a surface resistivity of from 1 to 100 MΩ/□, and it may, for example, be a layer on which the electric charge induced on the side of the front panel 1 for a touch sensor by applying electricity to transparent electrodes 5a provided on a touch panel main body 5 (see FIG. 3) disposed below the transparent substrate 2 is to be accumulated.

The constitution of the high resistance layer 3 is not particularly limited so long as it has a surface resistivity within the above range. For example, a layer containing tin oxide and titanium oxide as the main components or a layer containing niobium oxide and titanium oxide as the main components may be suitably used.

When the surface resistivity of the high resistance layer 3 is at least 1 MΩ/□, it is possible to prevent the operation of the touch panel main body 5 from being inhibited by electrical interaction of the high resistance layer 3 with the transparent electrodes 5a when electricity is applied to the transparent electrodes 5a of the touch panel main body 5. Further, when the surface resistivity of the high resistance layer 3 is at most 100 MΩ/□, the charged state based on the control voltage and the frequency is accurately developed, whereby the desired sense of touch can be developed with good reproducibility to the sensory receptor X, whereby an excellent sensor accuracy by the sense of touch can be obtained. The surface resistivity of the high resistance layer 3 is preferably from 5 to 60 MΩ/□.

The high resistance layer 3 is preferably a layer containing tin oxide and titanium oxide as the main components, whereby the surface resistivity can easily be controlled to be within the above preferred range, while a favorable luminous transmittance and a low luminous reflectance are secured.

The layer containing tin oxide and titanium oxide as the main components or the layer containing niobium oxide and titanium oxide as the main components, contains tin oxide and titanium oxide, or niobium oxide and titanium oxide, as the main components, and may contain another element such as Al, Si, Ga or In within a range not to impair the function of the high resistance layer 3.

The high resistance layer 3 may be formed on the transparent substrate 2 comprising e.g. a glass substrate, by sputtering such as DC (direct current) sputtering, AC (alternate current) sputtering or RF (radio-frequency) sputtering. Among them, DC magnetron sputtering is suitably used, since the process is stably conducted and film formation on a large area is easy.

Here, DC magnetron sputtering includes pulsed (a voltage is applied in a pulse waveform) DC magnetron sputtering. Pulsed DC magnetron sputtering is effective to prevent abnormal electric discharge.

The high resistance layer 3 is preferably one containing at least two metal elements, such as the above-described layer containing tin oxide and titanium oxide as the main components, whereby the surface resistivity will easily be controlled to be within the above preferred range, while it has a favorable light transmittance. For formation of such a high resistance layer 3, a so-called co-sputtering employing a plurality of targets each comprising a single element can be employed.

For example, in a case where a layer containing tin oxide and titanium oxide as the main components is to be formed by co-sputtering, as targets, a target containing tin as the main component and a target containing titanium as the main component are used.

The metal target containing tin as the main component may be one consisting solely of tin, or one containing tin as the main component doped with a known metal dopant other than tin, for example, Al or Si, within a range not to impair the effects of the present invention.

The metal target containing titanium as the main component may be one consisting solely of titanium, or one containing titanium as the main component doped with a known dopant other than titanium within a range not to impair the effects of the present invention.

As the sputtering gas, various reactive gases may be used. Specifically, for example, a mixed gas of an oxygen gas with an inert gas, or a mixed gas of an oxygen gas, a nitrogen gas and an inert gas may be used. The inert gas may, for example, be a rear gas such as helium, neon, argon, krypton or xenon. Among them, preferred is argon in view of the economical efficiency and the easiness of electric discharge. These gases may be used alone or as a mixture of two or more. As the sputtering gas, as the gas containing a nitrogen atom, N₂O, NO, NO₂, NH₃ or the like may also be used in addition to the nitrogen gas (N₂).

The partial pressures of the oxygen and the inert gas in the sputtering gas and the total pressure of the sputtering gas are not particularly limited so long as the glow discharge is stably conducted.

In a case where sputtering is carried out, the power density is preferably from 0.9 to 4 W/cm², more preferably from 0.9 to 3 W/cm². The film deposition time may be determined depending upon the deposition rate and the desired thickness.

Co-sputtering is to be conducted by simultaneously discharging the respective targets, and by controlling the power density applied to each target and the partial pressure of the sputtering gas, a coating film having a desired composition can be formed.

Formation of the high resistance layer 3 may also be carried out by a physical vapor deposition method other than sputtering, such as a vacuum deposition method, an ion beam assisted deposition method or an ion plating method, or a chemical vapor deposition method such as a plasma CVD method. Sputtering is preferably employed, whereby a uniform film thickness in a large area can easily be obtained.

In a case where the high resistance layer 3 is a layer containing tin oxide and titanium oxide as the main components, it is preferably a layer containing from 1 to 30 atomic %, more preferably from 5 to 20 atomic % of Ti based on the total amount (100 atomic %) of Sn and Ti. Further, in a case where the high resistance layer 3 is a layer containing niobium oxide and titanium oxide as the main components, it is preferably a layer containing from 90 to 99.9 atomic %, more preferably from 95 to 99.9 atomic % of Ti based on the total amount (100 atomic %) of Nb and Ti.

When the atomic ratio in the high resistance layer 3 is within the above range, the high resistance layer 3 is likely to have a surface resistivity within the above preferred range and a moderate refractive index.

The thickness of the high resistance layer 3 is preferably at least 5 nm and at most 100 nm, more preferably at least 5 nm and at most 50 nm, further preferably at least 5 nm and at most 30 nm. When the thickness of the high resistance layer 3 is at least 5 nm, a sufficient charge retention function will be obtained. Further, when the thickness of the high resistance layer 3 is at most 100 nm, a favorable luminous transmittance will be obtained.

In the present specification, the “thickness” of each layer is a thickness obtained by measurement by a stylus surface profiler.

The thickness of the high resistance layer 3 can be properly adjusted by the film deposition rate or the substantial film formation time when sputtering is carried out.

In the front panel 1 for a touch sensor, the refractive index (n) of the high resistance layer 3 is preferably from 1.8 to 2.5 with a view to obtaining excellent optical properties such as the luminous transmittance and the luminous reflectance.

The insulating layer 4 is a layer provided on the high resistance layer 3 or on the high resistance layer 3 with another layer interposed therebetween, and is to prevent the electric current based on the electric charge accumulated on the high resistance layer 3 from directly flowing into a sensory receptor X (see FIG. 3) such as a fingertip to be contacted to the surface of the front panel 1 for a touch sensor.

In this specification, the insulating layer 4 is a layer having a volume resistivity of at least 10¹⁰ Ω·cm. The volume resistivity is a value measured in accordance with JIS C2318-1975.

The insulating layer 4 is not particularly limited so long as it is transparent to light and has electrical insulating properties. For example, the after-mentioned layer made of a cured product formed by curing an ultraviolet curable composition (i) for forming an insulating layer or a thermosetting composition (ii) for forming an insulating layer by light or heat, may be used.

The ultraviolet curable composition (i) for forming an insulating layer may, for example, be one containing the after-mentioned ultraviolet curable polymerizable monomer (A), or may be one containing it and as the case requires, an ultraviolet absorber (B) and a photopolymerization initiator (C).

At least part of the ultraviolet curable polymerizable monomer (A) (hereinafter referred to as a monomer (A)) is preferably a polyfunctional polymerizable monomer (a-1) (hereinafter referred to as monomer (a-1)) having at least two acryloryl groups or methacryloyl groups in one molecule.

Hereinafter, both the polymerizable functional groups will be referred to as a (meth)acryloyl group. The same applies to a (meth)acrylate, (meth)acrylic acid and the like.

The polymerizable functional group is preferably an acryloyl group in view of high polymerizability, particularly high polymerizability by ultraviolet light. Accordingly, preferred as the following compound having (meth)acryloyl groups is a compound having acryloyl groups. Likewise, in the case of the (meth)acrylate, (meth)acrylic acid and the like, preferred is a compound having an acryloyl group. In one molecule of the compound having at least two (meth)acryloyl groups, the polymerizable functional groups may be different from each other (that is, at least one acryloyl group and at least one methacryloyl group may be contained), and preferably all the polymerizable functional groups are acryloyl groups.

The monomer (A) other than the monomer (a-1) may be a monofunctional polymerizable monomer (hereinafter referred to as monomer (a-2)) having one (meth)acryloyl group in one molecule or a compound having at least one ultraviolet curable polymerizable functional group other than the (meth)acryloyl group.

The monomer (A) other than the monomer (a-1) is preferably the monomer (a-2), since when the ultraviolet curable polymerizable functional group is a (meth)acryloyl group, a sufficient ultraviolet curability will be obtained, and such a compound is easily available. Accordingly, the monomer (A) preferably comprises substantially only one or more compounds having a (meth)acryloyl group(s) including the monomer (a-1). Hereinafter, the description will be made assuming that all the monomers (A) including the monomer (a-1) are compounds having a (meth)acryloyl group(s).

The monomer (A) may be a compound having a functional group or a bond in addition to the (meth)acryloyl group(s). For example, it may have a hydroxy group, a 3o carboxy group, a halogen atom, a urethane bond, an ether bond, an ester bond, a thioether bond or an amido bond. Particularly preferred is a (meth)acryloyl group-containing compound having a urethane bond (hereinafter referred to as an acrylic urethane) or a (meth)acrylic acid ester compound having no urethane bond.

The monomer (a-2) is usually a compound having no urethane bond, but the monomer (a-2) is not limited to a compound having no urethane bond. On the other hand, the monomer (a-1) may or may not have an urethane bond. The average number of (meth)acryloyl groups in one molecule of the monomer (a-1) is not particularly limited and is preferably from 2 to 50, particularly preferably from 2 to 30.

The acrylic urethane is obtainable by a reaction of a compound having a (meth)acryloyl group and a hydroxy group with a compound having an isocyanate group, a reaction of a compound having a (meth)acryloyl group and an isocyanate group with a compound having a hydroxy group and having no (meth)acryloyl group (hereinafter referred to as a hydroxy group-containing compound), a reaction of a compound having a (meth)acryloyl group and a hydroxy group, a compound having at least two isocyanate groups (hereinafter referred to as a polyisocyanate) and a hydroxy group-containing compound, or the like.

Hereinafter, the hydroxy group-containing compound (having no (meth)acryloyl group) means a compound having at least two hydroxy groups, unless otherwise specified.

In such compounds, at least two groups each of the (meth)acryloyl groups, the hydroxy groups and the isocyanate groups may be present in one molecule. In the acrylic urethane obtainable by such a reaction, a hydroxy group may be present, but no isocyanate group is preferably present.

The hydroxy group-containing compound having at least two hydroxy groups may, for example, be a polyhydric alcohol, a polyol having a high molecular weight as compared with a polyhydric alcohol, or a hydroxy group-containing vinyl polymer. Such hydroxy group-containing compounds may be used in combination of two or more.

An acrylic urethane preferred as the monomer (a-1) is a reaction product of a hydroxy group-containing (poly)pentaerythritol poly(meth)acrylate with a polyisocyanate. The (poly)pentaerythritol means pentaerythritol, a pentaerythritol multimer such as dipentaerythritol or a mixture containing it as the main component, and the average degree of multimerization is preferably from about 1 to 4, particularly preferably from about 1.5 to 3.

The poly(meth)acrylate thereof is preferably a compound which is an ester having at least two (meth)acryloyl groups and having from about 3 to 6 (meth)acryloyl groups on average per one molecule. Here, the (poly)pentaerythritol poly(meth)acrylate has at least about 1 hydroxy group on average per one molecule. Further, the average number of (meth)acryloyl groups per one molecule of the acrylic urethane as a reaction product is preferably at least 4, particularly preferably from 8 to 20.

The monomer (a-1) having no urethane bond is preferably a (meth)acrylate of the hydroxy group-containing compound or (meth)acrylic acid adduct of a polyepoxide. The hydroxy group-containing compound may, for example, be the above-mentioned polyhydric alcohol or high molecular weight polyol. As specific examples of the monomer (a-1) having no urethane bond, the following compounds may be mentioned.

The following (meth)acrylates of an aliphatic polyhydric alcohols. 1,4-Butanediol di(meth)acrylate, neopentyl glycol di(meth)acrylate, 1,6-hexanediol di(meth)acrylate, di(meth)acrylate of a C₁₄₋₁₅ long chain aliphatic diol, 1,3-butanediol di(meth)acrylate, ethylene glycol di(meth)acrylate, diethylene glycol di(meth)acrylate, glycerol tri(meth)acrylate, glycerol di(meth)acrylate, triglycerol di(meth)acrylate, trimethylolpropane tri(meth)acrylate, ditrimethylolpropane tetra(meth)acrylate, pentaerthritol tri(meth)acrylate, pentaerythritol tetra(meth)acrylate, dipentaerythritol hexa(meth)acrylate, dipentaerythritol penta(meth)acrylate and a di(meth)acrylate of a diol comprising a condensate of neopentyl glycol and trimethylolpropane.

The following (meth)acrylates of a polyhydric alcohol or a polyhydric phenol having the following aromatic nucleus or triazine ring. Bis(2-(meth)acryloyloxyethyl) bisphenol A, bis(2-(meth)acryloyloxyethyl) bisphenol S, bis(2-(meth)acryloyloxyethyl) bisphenol F, tris(2-(meth)acryloyloxyethyl) isocyanurate, and bisphenol A di(meth)acrylate.

The following (meth)acrylates of a hydroxy group-containing compound/alkylene oxide adduct, (meth)acrylates of a hydroxy group-containing compound/caprolactone adduct, and (meth)acrylates of a polyoxyalkylene polyol. In the following, EO represents ethylene oxide, PO propylene oxide and the value in the bracket [ ] the molecular weight of a polyoxyalkylene polyol. Tri(meth)acrylate of a trimethylolpropane/EO adduct, tri(meth)acrylate of a trimethylolpropane/PO adduct, triethylene glycol di(meth)acrylate, tetraethylene glycol di(meth)acrylate, tripropylene glycol di(meth)acrylate, hexa(meth)acrylate of a dipentaerythritol/caprolactone adduct, tri(meth)acrylate of a tris(2-hydroxyethyl)isocyanurate/caprolactone adduct, polyethylene glycol [200 to 1000] di(meth)acrylate, and polypropylene glycol [200 to 1000] di(meth)acrylate.

The following carboxylates and phosphates having a (meth)acryloyl group. Bis(acryloyloxyneopentyl glycol) adipate, di(meth)acrylate of neopentyl glycol hydroxypivalate ester, di(meth)acrylate of a neopentyl glycol hydroxypivalate ester/caprolactone adduct, bis(2-(meth)acryloyloxyethyl)phosphate, and tris(2-(meth)acryloyloxyethyl)phosphate.

The following (meth)acrylic acid adducts of a polyepoxide (provided that one molecule of (meth)acrylic acid is added per one epoxy group of the polyepoxide), and reaction products of glycidyl (meth)acrylate and a polyhydric alcohol or a polyhydric carboxylic acid (provided that at least two molecules of glycidyl (meth)acrylate are reacted per one molecule of the polyhydric alcohol or the like). A (meth)acrylic acid adduct of bisphenol A-diglycidyl ether, a vinyl cyclohexene dioxide/(meth)acrylic acid adduct, a dicyclopentadiene dioxide/(meth)acrylic acid adduct, a reaction product of glycidyl (meth)acrylate with ethylene glycol, a reaction product of glycidyl (meth)acrylate with propylene glycol, a reaction product of glycidyl (meth)acrylate with diethylene glycol, a reaction product of glycidyl (meth)acrylate with 1,6-hexanediol, a reaction product of glycidyl (meth)acrylate with glycerol, a reaction product of glycidyl (meth)acrylate with trimethylolpropane, and a reaction product of glycidyl (meth)acrylate with phthalic acid.

The following alkyl ether compounds, alkenyl ether compounds, carboxylate compounds and the like (hereinafter sometimes referred to as modified products) of the above (meth)acrylate having an unreacted hydroxy group. An alkyl-modified dipentaerythritol penta(meth)acrylate, an alkyl-modified dipentaerythritol tetra(meth)acrylate, an alkyl-modified dipentaerythritol tri(meth)acrylate, an allyl ether compound of a vinyl cyclohexene dioxide/(meth)acrylic acid adduct, a methyl ether compound of a vinyl cyclohexene dioxide/(meth)acrylic acid adduct, and stearic acid-modified pentaerythritol di(meth)acrylate.

Preferred as the monomer (a-1) which is a polyester having at least two (meth)acryloyloxy groups and having no urethane bond is the above-mentioned (poly)pentaerythritol poly(meth)acrylate. This (poly)pentaerythritol poly(meth)acrylate is a compound having at least two (meth)acryloyloxy groups on average per one molecule, and may or may not contain a hydroxy group. The degree of multimerization of the (poly)pentaerythritol moiety is preferably from about 1 to 4, particularly preferably from 1.5 to 3. More preferred as the (poly)pentaerythritol poly(meth)acrylate is (poly)pentaerythritol poly(meth)acrylate having substantially all hydroxy groups of (poly)pentaerythritol converted to (meth)acryloyloxy groups.

The monofunctional polymerizable monomer i.e. the monomer (a-2) may have a functional group such as a hydroxy group or an epoxy group. Preferred as the monofunctional compound is a (meth)acrylic acid ester i.e. a (meth)acrylate.

As a specific monofunctional compound, the following compounds may, for example, be mentioned. Methyl (meth)acrylate, ethyl (meth)acrylate, butyl (meth)acrylate, isobutyl (meth)acrylate, t-butyl (meth)acrylate, 2-ethylhexyl (meth)acrylate, lauryl (meth)acrylate, tridecyl (meth)acrylate, cyclohexyl (meth)acrylate, 2-hydroxyethyl (meth)acrylate, 2-hydroxypropyl (meth)acrylate, glycidyl (meth)acrylate, tetrahydrofurfuryl (meth)acrylate, benzyl (meth)acrylate, 1,4-butylene glycol mono(meth)acrylate, ethoxyethyl (meth)acrylate, and a (meth)acrylic acid adduct of phenyl glycidyl ether.

The monomers (a-1) may be used alone or in combination of two or more. It is preferred that at least one monomer (a-1) is a compound having from 2 to 10 (meth)acrylol groups.

The total proportion of the monomer (a-1) in the monomer (A) is preferably from 20 to 100 mass %, more preferably from 50 to 100 mass %, further preferably from 70 to 100 mass %. When the proportion of the monomer (a-1) is within such a range, sufficient abrasion resistance will be obtained.

A part or all of the ultraviolet absorber (B) comprises a polymerizable ultraviolet absorber (b-1). In a case where the amount of the ultraviolet absorber (B) is small, usually the entire amount comprises the polymerizable ultraviolet absorber (b-1). That is, in a case where the ultraviolet absorber is contained, the amount of the polymerizable ultraviolet absorber (b-1) per 100 parts by mass of the monomer (A) is preferably at least 0.1 part by mass, more preferably at least 1 part by mass. The upper limit is 50 parts by mass, preferably 30 parts by mass.

By use of the polymerizable ultraviolet absorber (b-1), bleeding of the ultraviolet absorber on the surface or a remarkable decrease of the abrasion resistance or the like will not occur even if an ultraviolet absorber in a relatively large amount is incorporated in the composition for forming an insulating layer.

The polymerizable ultraviolet absorber (b-1) may be at least one member selected from the following polymerizable benzophenone compounds and polymerizable benzotriazole compounds.

An ultraviolet absorber other than the polymerizable ultraviolet absorber (b-1) may be used in combination as the ultraviolet absorber (B), but use of such another ultraviolet absorber in a large amount is unfavorable.

The amount of the ultraviolet absorber other than the polymerizable ultraviolet absorber (b-1) is preferably at most 20 parts by mass, more preferably at most 10 parts by mass per 100 parts by mass of the monomer (A).

As the ultraviolet absorber other than the polymerizable ultraviolet absorber (b-1), a non-polymerizable ultraviolet absorber and a polymerizable ultraviolet absorber other than the polymerizable ultraviolet absorber (b-1) may be mentioned, but usually non-polymerizable ultraviolet absorber (hereinafter referred to as ultraviolet absorber (b-2)) is used. The proportion of the ultraviolet absorber other than the polymerizable ultraviolet absorber (b-1) is not particularly limited, and is preferably from 0 to 80 mass %, particularly preferably from 0 to 50 mass %, in the entire ultraviolet absorber (B).

The amount of use of the entire ultraviolet absorber (B) is preferably from 0 to 50 parts by mass, more preferably from 0 to 30 parts by mass per 100 parts by mass of the monomer (A). In a case where the proportion is at most 50 parts by mass, even when the entire amount of the ultraviolet absorber (B) comprises the polymerizable ultraviolet absorber (b-1), an obtainable cured coating film (insulating layer) to be the insulating layer is well cured and has excellent physical properties, although it depends on the thickness, the hardness and the light resistance required for the cured coating film. In a case where the ultraviolet absorber (B) is contained in an amount of at least 0.1 part by mass, the cured coating film itself has favorable weather resistance.

A polymerizable benzophenone compound is a compound having at least one (meth)acryloyl group and at least one benzophenone skeleton. Usually, a benzophenone compound having an ultraviolet absorbing power has at least one hydroxy group on at least one of two benzene rings in the benzophenone skeleton (usually the hydroxy group is present at the 2-position of the benzophenone skeleton).

The polymerizable benzophenone compound also preferably has at least one hydroxy group on at least one of the two benzene rings in the benzophenone skeleton, in addition to the organic group having a (meth)acryloyl group (hereinafter referred to as a (meth)acryloyl-containing group). This hydroxy group may be present on the benzene ring to which the (meth)acryloyl-containing group is bonded, or may be present on the other benzene ring. This hydroxy group is preferably present at the 2-position of the benzophenone skeleton.

In the polymerizable benzophenone compound, usually one (meth)acryloyl-containing group is present. However, at least two (meth)acryloyl-containing groups may be present, and in such a case, they may be present only one of the two benzene rings or may be present on both the benzene rings. The hydroxy group is preferably present on the benzene ring on which the (meth)acryloyl-containing group is present. Further, in the two benzene rings, at least one substituent other than the (meth)acryloyl-containing group and the hydroxy group may be present, and such a substituent is preferably a hydrocarbon group such as an alkyl group, an alkoxy group, a halogen atom or the like. The number of carbon atoms in the hydrocarbon group and the alkoxy group is preferably at most 6.

The (meth)acryloyl-containing group is preferably a (meth)acryloyloxy group or an organic group represented by the following formula (1):

—X¹—R¹—X²—CO—CR═CH₂ (1)

In the formula (1), R is a hydrogen atom or a methyl group, X¹ is an oxygen atom, —OCONH—, —OCH₂CH(OH)— or a single bond, R¹ is a bivalent hydrocarbon group, and X² is an oxygen atom, —O—(-COCH₂CH₂O—)ₖ- (k is an integer of at least 1), —NH—, or —CH(OH)CH₂O—. Preferably, R is a hydrogen atom, X¹ is an oxygen atom or a single bond, R¹ is a C₁₋₆ alkylene group, and X² is an oxygen atom.

Preferred as the (meth)acryloyl-containing group is a (meth)acryloyloxy group, a (meth)acryloyloxyalkyl group or a ((meth)acryloyloxy)alkoxy group, and the number of carbon atoms at a moiety other than the (meth)acryloyloxy group in the latter two groups is preferably from 2 to 4.

Preferred as the polymerizable benzophenone compound is a 2-hydroxybenzophenone having a (meth)acryloyl-containing group at the 4-position of a hydroxyphenyl group. This compound is represented by the following formula (2). In the following formula (2), A is the above-mentioned (meth)acryloyl-containing group, and each of R² and R³ is a substituent other than the (meth)acryloyl-containing group.

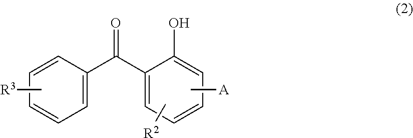

As specific examples of the polymerizable benzophenone compound, the following compounds may be mentioned. 2-Hydroxy-4-(meth)acryloyloxybenzophenone, 2-hydroxy-4-(2-(meth)acryloyloxyethoxy)benzophenone, 2-hydroxy-4-(2-acryloyloxypropoxy)benzophenone, 2,2′-dihydroxy-4-(meth)acryloyloxybenzophenone and 2,2′-dihydroxy-4-(2-(meth)acryloyloxyethoxy)benzophenone.

A polymerizable benzotriazole compound is a compound having at least one (meth)acryloyl group and at least one benzotriazole ring. Usually, a benzotriazole compound having an ultraviolet absorbing power has a skeleton in which one benzene ring is bonded at the 2-position of a benzotriazole ring. That is, it comprises 2-phenyl benzotriazole as the skeleton. Further, it has a hydroxy group at the 2-position of the phenyl group.

The polymerizable benzotriazole compound is also preferably such a compound comprising 2-phenyl benzotriazole as the skeleton and having a hydroxy group at the 2-position of the phenyl group. The (meth)acryloyl-containing group may be present at from 4- to 8-position of the benzotriazole ring, and is preferably present at from 3- to 6-position of the phenyl group. Further, at least two (meth)acryloyl-containing groups may be present, and preferably one (meth)acryloyl-containing group is present.

At 4- to 8-positions of the benzotrizole ring and at 3- to 6-positions of the phenyl group, where no (meth)acryloyl-containing group is present, at least one substituent may be present, and such a substituent is preferably a hydrocarbon group such as an alkyl group, a hydroxy group, an alkoxy group or a halogen atom. The number of carbon atoms in the hydrocarbon group or the alkoxy group is preferably at most 6.

The (meth)acryloyl-containing group is preferably a (meth)acryloyloxy group or an organic group represented by the above formula (1). More preferred as the (meth)acryloyl-containing group is a (meth)acryloyloxy group, a (meth)acryloyloxyalkyl group or a ((meth)acryloyloxy)alkoxy group, as mentioned above, and the number of carbon atoms at a moiety other than the (meth)acryloyloxy group moiety in the latter two groups is preferably from 2 to 4.

Preferred as the polymerizable benzotriazole compound is a 2-(2-hydroxyphenyl)benzotriazole having a (meth)acryloyl-containing group at the 5-position of the 2-hydroxyphenyl group. This compound is represented by the following formula (3). In the following formula (3), A is the above-mentioned (meth)acryloyl-containing group, and each of R⁴ and R⁵ is a substituent other than the (meth)acryloyl-containing group.

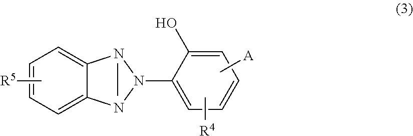

As specific examples of the polymerizable benzotriazole compound, the following compounds may be mentioned.

2-{2-Hydroxy-5-((meth)acryloyloxy)phenyl}benzotriazole, 2-{2-hydroxy-3-methyl-5-((meth)acryloyloxy)phenyl}benzotriazole, 2-{2-hydroxy-3-t-butyl-5-((meth)acryloyloxy)phenyl}benzotriazole, 2-{2-hydroxy-5-(2-(meth)acryloyloxyethyl)phenyl}benzotriazole, 2-{2-hydroxy-5-(3-(meth)acryloyloxypropyl)phenyl}benzotriazole, and 2-{2-hydroxy-3-t-butyl-5-(2-(meth)acryloyloxyethyl)phenyl}benzotriazole.

2-{2-Hydroxy-3-t-butyl-5-(3-(meth)acryloyloxypropyl)phenyl}benzotriazole, 2-{2-hydroxy-3-methyl-5-(2-(meth)acryloyloxyethyl)phenyl}benzotriazole, 2-{2-hydroxy-3-methyl-5-(3-(meth)acryloyloxypropyl)phenyl}benzotriazole, 2-{2-hydroxy-5-(2-(meth)acryloyloxyethyl)phenyl}-5-chlorobenzotriazole, 2-{2-hydroxy-5-(2-(meth)acryloyloxyethyl)phenyl}-5-methylbenzotriazole, 2-{2-hydroxy-5-(2-(2-(meth)acryloyloxyethoxycarbonyl)ethyl)phenyl}benzotriazole, 2-{2-hydroxy-5-(2-(meth)acryloyloxyethoxy)phenyl}benzotriazole, and 2-{2-hydroxy-5-(2-(meth)acryloyloxypropoxy)phenyl}benzotriazole.

As the ultraviolet absorber (b-2), a commercially available known ultraviolet absorber may be used. Such an ultraviolet absorber may, for example, be a benzotriazole type ultraviolet absorber, a benzophenone type ultraviolet absorber, a salicylic acid type ultraviolet absorber or a phenyl triazine type ultraviolet absorber. Specifically, for example, the following compounds may be mentioned.

Octyl 3-{3-(2H-benzotriazol-2-yl)-5-t-butyl-4-hydroxyphenyl}propionate, 2-(3,5-di-t-pentyl-2-hydroxyphenyl)benzotriazole, 2-(2-hydroxy-5-methylphenyl)benzotriazole, 2-(2-hydroxy-3,5-di-t-butylphenyl)benzotriazole, 2-(2-hydroxy-3-t-butyl-5-methylphenyl)-5-chlorobenzotriazole, 2-(2-hydroxy-3,5-di-t-butylphenyl)-5-chlorobenzotriazole, 2,4-dihydroxybenzophenone, 2-hydroxy-4-methoxybenzophenone, 2,2′-dihydroxy-4-methoxybenzophenone, and p-t-butylphenyl salicylate.

The photopolymerization initiator (C) may, for example, be an aryl ketone type photopolymerization initiator (such as an acetophenone, a benzophenone, an alkylaminobenzophenone, a benzyl, a benzoin, a benzoin ether, a benzyldimethylketal, a benzoyl benzoate or an α-acyloxime ester), a sulfur-containing photopolymerization initiator (such as a sulfide or a thiaxanthone), an acylphosphine oxide (such as acyldiarylphosphine oxide) or another photopolymerization initiator. Such photopolymerization initiators may be used in combination of two or more. Further, the photopolymerization initiator may be used in combination with a photosensitizer such as an amine. As specific examples of the photopolymerization initiator, the following compounds may be mentioned.

4-Phenoxydichloroacetophenone, 4-t-butyl-dichloroacetophenone, 4-t-butyl-trichloroacetophenone, diethoxyacetophenone, 2-hydroxy-2-methyl-1-phenylpropan-1-one, 1-(4-isopropylphenyl)-2-hydroxy-2-methylpropan-1-one, 1-(4-dodecylphenyl)-2-methylpropan-1-one, 1-{4-(2-hydroxyethoxy)phenyl}-2-hydroxy-2-methyl-propan-1-one, 1-hydroxycyclohexyl phenyl ketone, 2-methyl-1-{4-(methylthio)phenyl}-2-morpholinopropan-1-one.

Benzyl, benzoin, benzoin methyl ether, benzoin ethyl ether, benzoin isopropyl ether, benzoin isobutyl ether, benzyldimethylketal, benzophenone, benzoyl benzoate, methyl benzoyl benzoate, 4-phenylbenzophenone, hydroxybenzophenone, acrylated benzophenone, 3,3′-dimethyl-4-methoxybenzophenone, 3,3′,4,4′-tetrakis(t-butylperoxycarbonyl)benzophenone, 9,10-phenanthrenequinone, camphorquinone, dibenzosuberone, 2-ethylanthraquinone, 4′,4″-diethylisophthalophenone, α-acyloxime ester and methyl phenyl glyoxylate.

4-Benzoyl-4′-methyl diphenyl sulfide, thioxanthone, 2-chlorothioxanthone, 2-methylthioxanthone, 2,4-dimethylthioxanthone, isopropylthioxanthone, 2,4-dichlorothioxanthone, 2,4-diethylthioxanthone, 2,4-diisopropylthioxanthone, and 2,4,6-trimethylbenzoyl diphenylphosphine oxide.

The amount of use of such a photopolymerization initiator (C) is preferably from 0.1 to 20 parts by mass per 100 parts by mass of the monomer (A).

In the composition for forming an insulating layer, as the case requires, a stabilizer such as an antioxidant, a photostabilizer or a thermal polymerization inhibitor, a leveling agent, a defoaming agent, a thickener, an anti-settling agent, a pigment dispersant, an anti-fogging agent, a fluorinated surfactant, silicone surfactant or hydrocarbon surfactant for surface tension adjustment, a near infrared absorber, etc. may suitably be incorporated.

In the composition for forming an insulating layer, further, colloidal silica (D) may be incorporated for the purpose of further improving the abrasion resistance of the obtainable cured coating film. The colloidal silica (D) is ultrafine particles of silicic anhydride dispersed in a dispersion medium comprising water, methanol or the like to form a colloidal dispersion. The average particle size of the colloidal silica (D) is usually at a level of from 1 to 1,000 nm and is not particularly limited, and is preferably from 1 to 200 nm, particularly preferably from 1 to 50 nm.

Further, the colloidal silica (D) may be one having the particle surface modified with a hydrolyzate of a hydrolyzable silane compound so as to improve the dispersion stability, i.e. one wherein a hydrolyzate of a silane compound is held by some or all of silanol groups on the surface of the colloidal silica particles, whereby the surface properties are modified.

In a case where the colloidal silica (D) is incorporated in the composition (i) for forming an insulating layer, its amount (solid content) is preferably at most 500 parts by mass, particularly preferably at most 300 parts by mass per 100 parts by mass of the monomer (A). In a case where the colloidal silica (D) is incorporated, by incorporating it in an amount of at least 0.1 part by mass per 100 parts by mass of the monomer (A), effects by its incorporation will be obtained.

Further, it is also preferred to incorporate a photostabilizer so as to improve the stability against light other than the ultraviolet absorber (B). The photostabilizer is preferably a hindered amine type photostabilizer, particularly a hindered amine type photostabilizer having a 2,2,6,6-tetramethylpiperidine residue. Specifically, for example, bis(2,2,6,6-tetramethyl-4-piperidyl)sebacate, bis(1,2,2,6,6-pentamethyl-4-piperidyl)sebacate, or 2-(3,5-di-t-butyl-4-hydroxybenzyl)-2-n-butylmalonate bis(1,2,2,6,6-pentamethyl-4-piperidyl) may be mentioned. In a case where such a photostabilizer is incorporated, its amount is preferably at most 10 parts by mass, particularly preferably at most 5 parts by mass per 100 parts by mass of the monomer (A).

Further, in order to impart the water repellency to the insulating layer 4, a fluorinated polymerizable monomer (e-1) represented by the following formula (4) may be incorporated as a water repellent monomer (E) in the composition for forming an insulating layer.

CH₂═C(R⁶)COOX³R^{f} (4)

wherein R⁶ is a hydrogen atom, a methyl group or a trifluoromethyl group, X³ is a C₁₋₆ bivalent organic group, and R^{f} is a C₄₋₆ perfluoroalkyl group.

As examples of the fluorinated polymerizable monomer (e-1) represented by the formula (4), the following may be mentioned.

CH₂═C(R⁶)COOR⁷R^{f}

CH₂═C(R)COOR⁷NR⁸SO₂R^{f}

CH₂═C(R⁶)COOR⁷NR⁸COR^{f}

CH₂═C(R⁶)COOCH₂CH(OH)R⁹R^{f}

wherein R⁷ is a C₁₋₆ alkylene group, R⁸ is a hydrogen atom or a C₁ alkyl group, and R⁹ is a single bond or a C₁ alkylene group.

In the above formula (4), X³ is preferably a C₂₋₄ alkylene group in view of availability.

As specific examples of the fluorinated polymerizable monomer (e-1) represented by the above formula (4), perfluorohexylethyl (meth)acrylate and perfluorobutylethyl (meth)acrylate may be mentioned.

The monomers represented by the above formula (4) may be used alone or in combination of two or more.

By R^{f} being a C₄₋₆ perfluoroalkyl group, the fluorinated polymerizable monomer (e-1) is compatible with other components such as the polymerizable monomer (A), and when a coating film of the composition (i) for forming an insulating layer is cured, the polymers will not coagulate with each other. Thus, the obtainable insulating layer 4 as a cured product will not become cloudy but have a favorable outer appearance, and the adhesion between the insulating layer 4 and its underlayer (for example, the high resistance layer 3) will be high. When R^{f} is a perfluoroalkyl group having at least 4 carbon atoms, the water repellency of the insulating layer 4 will be favorable. On the other hand, when R^{f} is a perfluoroalkyl group having at most 6 carbon atoms, when the coating film is cured, the obtainable insulating layer 4 as a cured product will not become cloudy, and the adhesion between the insulating layer 4 and its underlayer (for example, the high resistance layer 3) will be favorable.

Further, in the composition (i) for forming an insulating layer, an organic solvent may be incorporated for the purpose of improving the coating properties of the coating film, or adhesion to the underlayer such as the high resistance layer 3. The organic solvent is not particularly limited so long as it has no problem with solubility of the monomer (A), the ultraviolet absorber (B) and other additives, and any organic solvent which satisfies the above performance may be used. Further, at least two organic solvents may be used in combination. The amount of the organic solvent is properly at most 100 times by mass, particularly at most 50 times by mass, relative to the monomer (A).

The organic solvent may, for example, be an organic solvent such as a lower alcohol, a ketone, an ether or a cellosolve. In addition, an ester such as n-butyl acetate or diethylene glycol monoacetate, a haloganated hydrocarbon, a hydrocarbon or the like may also be used.

The insulating layer 4 made of a cured product of the ultraviolet curable composition (i) for forming an insulating layer may be formed by applying the composition (i) for forming an insulating layer containing the above components on a stack having the high resistance layer 3 by a spin coating method, a dip coating method, a flow coating method, a spray coating method, a bar coating method, a gravure coating method, a roll coating method, a blade coating method or an air knife coating method, followed by drying in the case of a composition containing an organic solvent, and then irradiating the resulting film with ultraviolet light for curing.

For example, in a case where the composition for forming an insulating layer is applied by a spin coating method, the composition (i) for forming an insulating layer is dropped on a stack having the high resistance layer 3, and a stage on which the stack is placed and fixed is rotated at a predetermined number of revolutions, whereby a uniform thin film of the composition (i) for forming an insulating layer can be formed on the stack.

Specifically, for example, in a case where the amount of the composition (i) for forming an insulating layer dropped on the stack having the high resistance layer 3 is about 1 cm³, it is preferred that the stage on which the stack is placed is rotated at an initial number of revolutions of from 100 to 300 rpm for from about 10 to about 15 seconds, and then rotated at a maximum number of revolutions of from 1,500 to 2,500 rpm for from about 0.1 to about 1.0 second.

In a case where the composition (i) for forming an insulating layer contains an organic solvent, the stack after coating film formation is preferably maintained for example at a temperature range of from 100 to 150° C. for about 10 minutes to remove the organic solvent.

The ultraviolet light source may, for example, be a xenon lamp, a low pressure mercury lamp, a high pressure mercury lamp, an ultrahigh pressure mercury lamp, a metal halide lamp, a carbon arc lamp or a tungsten lamp.

The irradiation time and the irradiation intensity with ultraviolet light may be properly changed depending upon conditions such as the type of the monomer (A), the type of the ultraviolet absorber (B), the type of the photopolymerization initiator (C), the coating film thickness and the ultraviolet light source. Usually, irradiation for from about 1 to about 60 seconds is sufficient. Further, for the purpose of completing the curing reaction, heat treatment may be carried out after the irradiation with ultraviolet light.

The irradiation time and the irradiation intensity with ultraviolet light are preferably properly adjusted so that the energy integrated value is from about 500 to about 2,000 mJ/cm² and the peak value of the irradiation intensity becomes from 100 to 500 mW/cm².

in a case where the above ultraviolet curable composition (i) for forming an insulating layer is applied on the high resistance layer 3 comprising an inorganic oxide and cured to form the insulating layer 4, the composition (i) for forming an insulating layer is applied preferably after a surface treatment (hereinafter referred to as adhesion treatment) to increase the adhesion to the resin component is applied to the upper surface of the high resistance layer 3, in order to increase the adhesion between the high resistance layer 3 and the insulating layer 4.

For the surface treatment for improving the adhesion, for example, the following silane coupling agent may be used.

For example, 3-aminopropyltrimethoxysilane, 3-aminopropylmethyldimethoxysilane, N-(2-aminoethyl)-3-aminopropylmethyldimethoxysilane, N-(2-aminoethyl)-3-aminopropyltrimethoxysilane, 3-glycidoxypropyltrimethoxysilane, 3-glycidoxypropyltriethoxysilane, 3-glycidoxypropylmethyldiethoxysilane, 3-methacryloxypropylmethyldimethoxysilane, 3-methacryloxypropyltrimethoxysilane and 3-acryloxypropyltrimethoxysilane may be mentioned as the silane coupling agent to be used for the surface treatment.

The adhesion treatment may be carried out by applying a composition having the above silane coupling agent mixed with an organic solvent such as a lower alcohol, a ketone, an ether or a cellosolve to the upper surface of the high resistance layer 3 by e.g. a spin coating method, a dip coating method, a flow coating method, a spray coating method, a bar coating method, a gravure coating method, a roll coating method, a blade coating method or an air knife coating method, followed by drying.

For example, in a case where the adhesion treatment on the upper surface of the high resistance layer 3 is carried out by employing a spin coating method, a composition containing the above-described silane coupling agent is dropped on a stack having the high resistance layer 3, and a stage on which the stack is placed and fixed is rotated at a predetermined number of revolutions to form a thin film of the composition containing the silane coupling agent on the upper surface of the stack, whereby the adhesion treatment is conducted.

Specifically, in a case where the amount of the composition containing the silane coupling agent dropped on the upper surface of the high resistance layer 3 is about 1 cm³, the stage on which the stack is placed is rotated preferably at an initial number of revolutions of from 500 rpm to 1,500 rpm for from about 5 to about 15 seconds and then at a maximum number of revolutions of from 1,500 rpm to 2,500 rpm for from 0.1 to 1.0 second.

In a case where the composition used for the adhesion treatment contains an organic solvent, the stack after the adhesion treatment is preferably maintained at from 100 to 150° C. for 30 minutes to remove the organic solvent.

The thermosetting composition (ii) for forming an insulating layer is not particularly limited so long as a cured product having light transparency is obtainable after heat curing, and it may, for example, be preferably one containing an aqueous/organic solvent dispersion (F) containing solid components comprising colloidal silica (f-1) and a partially condensed product (f-2) of an organoalkoxysilane represented by the following formula (5).

The organoalkoxysilane may, for example, be one represented by the following formula (5):

(R¹⁰)ₐSi(OR¹¹)₄₋ₐ (5)

wherein R¹⁰ is a C₁₋₆ monovalent hydrocarbon group, R¹¹ is a C₁₋₆ monovalent hydrocarbon group or a hydrogen atom, and a is an integer of from 0 to 2.

Each of R¹⁰ and R¹¹ is preferably a C₁₋₄ alkyl group.

The organoalkoxysilane included in the range of the above formula (5) is preferably methyltrimethoxysilane, methyltrihydroxysilane or a mixture thereof, which may form the partially condensed product (f-2). In addition, the organotrialkoxysilane included in the range of the formula (5) may, for example, be tetraethoxysilane, ethyltriethoxysilane, diethyldiethoxysilane, tetramethoxysilane, methyltrimethoxysilane or dimethyldimethoxysilane.

The aqueous/organic solvent dispersion (F) may be one as disclosed in U.S. Pat. No. 3,986,997 by Clark.

Further, other than the above, the aqueous/organic solvent dispersion (F) may, for example, be ones as disclosed in U.S. Pat. Nos. 3,986,997, 4,624,870, 4,680,232 and 4,914,143.

The aqueous/organic solvent dispersion (F) may be produced specifically by adding a trialkoxysilane such as methyltrimethoxysilane to an aqueous dispersion of colloidal silica. Such an aqueous dispersion of colloidal silica may, for example, be “Ludox HS” (manufactured by DuPont), “Nalco” 1034A (manufactured by Nalco Chemical Co.), “OSCAL” (tradename, manufactured by Catalysts & Chemicals Industries Co., Ltd.) or “ORGANOSILICASOL” (tradename, manufactured by Nissan Chemical Industries, Ltd.).

The aqueous dispersion of the colloidal silica (f-1) may, for example, be one as disclosed in U.S. Pat. No. 4,177,315 by Ubersax.

The partially condensed product (f-2) of the organoalkoxysilane preferably contains from about 90 to about 95 mass % of a mixture of the organoalkoxysilane.

The aqueous/organic solvent dispersion (F) itself (i.e. a combination of the colloidal silica (f-1) and the partially condensed product (f-2) of the organoalkoxysilane) usually has a solid content of from about 10 mass % to about 50 mass %, preferably from about 15 mass % to about 25 mass %.

For the thermosetting composition (ii) for forming an insulating layer, an adhesion promoter (G) is preferably mixed with the aqueous/organic solvent dispersion (F) containing the above organoalkoxysilane and colloidal silica (f-1) and a sufficient amount of an alcohol, so as to improve the bonding properties to a substrate to which the composition is applied.

The adhesion promoter (G) may, for example, be an acrylate ester or a methacrylate ester as disclosed in U.S. Pat. No. 5,411,807. The acrylate ester or the methacrylate ester may, for example, be specifically Tone monomer commercially available from Union Carbide Coating Resins.

As the acrylate ester or the methacrylate ester, for example, caprolactone acrylate or caprolactone methacrylate may suitably be used as the adhesion promoter (G).

The acrylate ester or the methacrylate ester is used usually in an amount of from about 1 to about 20 parts by mass, preferably from about 3 to about 8 parts by mass, per 100 parts by mass of the resin solid content.

As the adhesion promoter (G), in addition to the above ones, a polyester polyol may be used. As the polyester polyol, for example, a caprolactone type polyester polyol as disclosed in U.S. Pat. No. 5,349,002 may be used.

Many of caprolactone type polyester polyols are bifunctional or trifunctional, and for example, Tone polyols commercially available from Union Carbide Coating Resins. Specifically, for example, “Tone 0200 diol” (tradename, manufactured by Union Carbide Coating Resins), “Tone 0301 triol” (tradename, manufactured by Union Carbide Coating Resins) or “Tone 0310 triol” (tradename, manufactured by Union Carbide Coating Resins) may be used.

Further, various commercially available Tone polyols differing in the molecular weight, the hydroxy value, the melting point, the viscosity and the like from the above-mentioned Tone polyols may also be used as the adhesion promoter (G).

The polyester polyol other than the caprolactone type polyester polyol may be a urethane-modified polyester polyol or a silicone-modified polyester polyol.

The polyester polyol may be used usually in an amount of from about 1 to 10 parts by mass per 100 parts by mass of the resin solid content.

As the adhesion promoter (G), in addition to the above ones, an acrylated polyurethane or a methacrylated polyurethane may be used. The acrylated polyurethane or the methacrylated polyurethane may, for example, be ones as disclosed in U.S. Pat. No. 5,503,935. The acrylated polyurethane or the methacrylated polyurethane usually has a molecular weight within a range of from about 400 to about 1,500, and is usually semi-solid or viscous, and can be directly added to a silicone dispersion.

The acrylated polyurethane may, for example, be specifically commercially available products such as “Actilane CB-32” (tradename, manufactured by SNPE Chimie (France)) and “Ebecryl 8804” (tradename, manufactured by Radcure Specialties (Louisville, Ky.)). The methacrylated urethane may, for example, be specifically a commercially available product such as “M-407” (tradename, manufactured by Echo Resins & Laboratory). Here, “M-407” is an adduct of isophorone diisocyanate and 2-hydroxyethyl methacrylate having a molecular weight of about 482.

The acrylated polyurethane or the methacrylate polyurethane may be used usually in an amount of from about 1 to about 15 parts by mass per 100 parts by mass of the resin solid content.

As the adhesion promoter (G), in addition to the above ones, an acrylic copolymer having a (number average) molecular weight of from about 1,000 to about 10,000 having a reactive moiety or an interactive moiety may be used. Such an acrylic copolymer (which is usually thermosetting) may, for example, be ones as disclosed in U.S. Pat. No. 5,503,935, which can be directly added to a silicone dispersion.

The acrylic copolymer has, as the reactive moiety or the interactive moiety, hydroxy groups, and has a hydroxy value within a range of from about 30 to about 160, an acid value less than about 4, and a (number average) molecular weight of from about 1,000 to about 10,000.

The acrylic copolymer may, for example, be ones as disclosed in “Encyclopedia of Polymer Science and Engineering, Mark et al., Vol. 4 published by John Wiley & Sons, 1986, at pages 374 to 375”, and they may be prepared by radical polymerization of various comonomers.

The acrylic copolymer can have appropriate properties in combination, by using a plurality of monomers, as disclosed in Organic Polymer Chemistry by K. J. Saunders, published by Chapman Hall (London), 1973.

For example, in a case where a monomer such as acrylonitrile or methyl methacrylate is used, usually, hardness is imparted to the obtainable copolymer, and in a case where a monomer such as ethyl acrylate or 2-ethylhexyl acrylate is used, flexibility is imparted to the obtainable copolymer. Further, by using a monomer such as dimethylaminoethyl methacrylate or acrylic acid, usually a reactive moiety suitable for polymerization is imparted.

The acrylic copolymer as the adhesion promoter (G) may have an amino group, a carboxy group, an amido bond, an epoxy group, a hydroxy group or an acyloxy group.

As the acrylic copolymer, specifically, an acrylic polyol “Joncryl (trademark)” (tradename, manufactured by BASF) or an acryloid acrylic resin (manufactured by Rohm and Haas Company) may, for example, be used as the adhesion promoter (G).

As disclosed in U.S. Pat. No. 5,503,935, the acrylic copolymer is preferably a hydroxyalkyl acrylate type, which has a reactive moiety or an interactive moiety with a silanol. As the acrylic copolymer, one prepared by a method as disclosed in the article “Journal of Coating Technology, Kamath et al., Vol. 59, No. 746 (March, 1987)” at pages 51 to 56 may be used as a preferred adhesion promoter (G).

The acrylic copolymer may be used usually in an amount of from about 1 to about 15 parts by mass per 100 parts by mass of the resin solid content.

For production of the aqueous/organic solvent dispersion (F) for example, an organic solvent such as a C₁₋₄ alkanol such as methanol, ethanol, propanol, isopropanol or butanol; or a glycol or glycol ether such as propylene glycol methyl ether, or a mixture thereof may be suitably used.

In a case where the thermosetting composition (ii) for forming an insulating layer contains the above aqueous/organic solvent dispersion (F), the composition (ii) for forming an insulating layer preferably contains the adhesion promoter (G) comprising an acrylic polyol in an amount of from 1 to 10 parts by mass per 100 parts by mass of the aqueous/organic solvent dispersion (F) containing solid components comprising from 10 to 70 mass % of the colloidal silica (f-1) and from 30 to 90 mass % of the partially condensed product (f-2) of the organoalkoxysilane represented by the formula (5), in a proportion of from 10 to 50 mass %.

An ultraviolet absorber (J) to be incorporated in the thermosetting composition (ii) for forming an insulating layer is suitably one which co-reacts with a silane, and which will not substantially volatilize during the heat curing step. The ultraviolet absorber (J) may, for example, be 4[γ-(trimethoxysilyl)propoxy]-2, hydroxybenzophenone, 4[γ-(triethoxysilyl)propoxy]-2, hydroxybenzophenone or a mixture thereof. The ultraviolet absorber (J) may be incorporated at a concentration of from 0.1 to 20 mass % in the thermosetting composition (ii) for forming an insulating layer.

In the thermosetting composition (ii) for forming an insulating layer, another additive such as a free-radical initiator, a sterically hindered amine type photostabilizer, an antioxidant, a dye, a flowability-improving agent, a leveling agent or a surface lubricant may be incorporated.

In the thermosetting composition (ii) for forming an insulating layer, to shorten the curing time, as a catalyst, a tetrabutylammonium carboxylate catalyst such as tetra-n-butylammonium acetate (TBAA) or tetra-n-butylammonium formate may be incorporated.

The insulating layer 4 made of a cured product of the thermosetting composition (ii) for forming an insulating layer may be formed by applying the above thermosetting composition (ii) for forming an insulating layer on the upper surface of a stack having the high resistance layer 3 by an optional known coating method such as a spin coating method, a dip coating method, a flow coating method, a spray coating method, a bar coating method, a gravure coating method, a roll coating method, a blade coating method or an air knife coating method, and curing the composition by heating at from 100 to 150° C. for from about 30 to about 90 minutes or by applying infrared or microwave energy.

For example, in a case where the composition (ii) for forming an insulating layer is applied by employing a spin coating method, the composition (ii) for forming an insulating layer is dropped on a stack having the high resistance layer 3, and a stage on which the stack is placed and fixed is rotated at a predetermined number of revolutions, whereby a uniform thin film of the composition (ii) for forming an insulating layer can be formed on the upper surface of the stack.

Specifically, for example, when the amount of the composition (ii) for forming an insulating layer dropped on the stack having the high resistance layer 3 is about 1 cm³, the stage on which the stacked is placed and fixed is preferably rotated at an initial number of revolutions of from 100 to 300 rpm for from about 10 to about 15 seconds and then at a maximum number of revolutions of from about 1,500 to about 2,500 rpm for from 0.1 to 1.0 second.

By the insulating layer 4 being a layer formed by curing the above composition for forming an insulating layer, the rate of formation of the insulating layer 4 is increased, whereby the efficiency for production of the front panel 1 for a touch sensor can be increased.

In a case where the insulating layer 4 is a layer made of cured product of the composition for forming an insulating layer, its thickness is preferably at least 1 μm and at most 100 μm, more preferably at least 1 μm and at most 30 μm, further preferably at least 1 μm and at most 10 μm.

When the thickness of the insulating layer 4 made of a cured product of the composition for forming an insulating layer is at least 1 μm, sufficient abrasion resistance and weather resistance of the insulating layer 4 can be obtained. On the other hand, when the thickness of the insulating layer 4 made of a cured product of the composition for forming an insulating layer is at most 100 μm, curing will sufficiently proceed even at a deep portion of the insulating layer 4, whereby excellent light transmittance will be obtained, and in addition, sufficient bending strength of the front panel 1 for a touch sensor can be obtained.

Further, the insulating layer 4 is not limited to a layer made of a cured product of the composition for forming an insulating layer, and may be a layer containing, as the main component, an inorganic oxide having electrical insulating property i.e. the above-described volume resistivity and having light transmittance.

The insulating layer 4 comprising a layer containing an inorganic oxide as the main component may, for example, be a layer containing silicon oxide as the main component or a layer containing aluminum oxide as the main component. Among them, a layer containing silicon oxide as the main component is suitably used, since it has sufficient abrasion resistance and weather resistance while maintaining favorable light transmittance and low reflectance to visible light.

The layer containing silicon oxide as the main component may be a layer consisting solely of silicon oxide, or a layer containing silicon oxide as the main component and containing at least one member selected from boron and phosphorus as an added element other than silicon.

The insulating layer 4 comprising a layer containing an inorganic oxide as the main component may be formed on a stack having the high resistance layer 3 by sputtering such as DC (direct current) sputtering such as DC (direct current) magnetron sputtering, AC (alternating current) sputtering or RF (radio-frequency) sputtering, in the same manner as formation of the high resistance layer 3.

In a case where the insulating layer 4 is a layer containing silicon oxide as the main component, as a target to be used for formation of the high resistance layer 3, a target containing silicon as the main component may be used. The target containing silicon as the main component may be one consisting solely of silicon, or may be one containing silicon as the main component doped with an element other than silicon, for example, a known dopant such as boron or phosphorus, within a range not to impair the effects of the present invention.

Formation of the insulating layer 4 comprising a layer containing an inorganic oxide as the main component by sputtering may be carried out by properly adjusting conditions such as the pressure of the sputtering gas and the film deposition rate, in the same manner as sputtering for the high resistance layer 3.

Further, formation of the layer containing an inorganic oxide constituting the insulating layer is not limited to a sputtering method, and may be carried out by a physical vapor deposition method other than the sputtering method, such as a vacuum deposition method, an ion beam assisted deposition method or an ion plating method, or a chemical vapor deposition method such as a plasma CVD method.

In a case where the insulating layer 4 is the above layer containing an inorganic oxide, its thickness is preferably at least 50 nm and at most 5 μm, more preferably at least 50 nm and at most 1 μm, further preferably at least 50 nm and at most 500 nm.

When the thickness of the insulating layer 4 is at least 50 nm, sufficient abrasion resistance and weather resistance of the insulating layer 4 can be obtained. Further, when the thickness of the insulating layer 4 is at most 5 μm, the insulating layer 4 has a moderate bending strength and further has a sufficient light transmittance. Further, when the thickness of the insulating layer 4 is at most 500 nm, the angle dependence of the reflected color can be reduced, and excellent visibility will be obtained.

In the front panel 1 for a touch sensor, the refractive index (n) of the insulating layer 4 is preferably from 1.3 to 1.8 with a view to obtaining excellent optical properties such as the luminous transmittance and the luminous reflectance.

In a case where the insulating layer 4 contains no component to impart water repellency such as the above fluorinated polymerizable monomer (e-1), moisture which is brought into contact with the surface of the insulating layer 4 is likely to be diffused in and attached to the surface of the insulating layer 4, whereby the electrostatic attraction (Coulomb force) working between the high resistance layer 3 on which the electric charge is accumulated and the sensory receptor X such as a fingertip close to the surface layer of the insulating layer 4 will be blocked out, and accordingly no sufficient functions as a touch sensor may be obtained. Accordingly, on the upper surface of an insulating layer 4 which does not contain a sufficient amount of a component to impart the water repellency, a water repellent layer 6 is preferably further formed as shown in FIG. 4.

Specifically, for example, a water repellent layer 6 is preferably formed on the upper surface of the insulating layer 4, in a case where the insulating layer 4 is a layer constituted by an insulating material containing an inorganic oxide as the main component, or in a case where the insulating layer 4 is a layer made of a cured product of the ultraviolet curable composition (i) for forming an insulating layer containing no component to impart the water repellency such as the fluorinated polymerizable monomer (e-1).

More specifically, it is more preferred to form a water repellent layer 6 on the upper surface of the insulating layer 4, for example, when it is a layer containing a silicon oxide as the main component. By such a constitution, blocking of the electrostatic attraction (Coulomb force) working between the high resistance layer 3 and the sensory receptor X, by moisture in contact with the surface of the insulating layer 4, can be suppressed, whereby sufficient functions as a touch sensor of the front panel 1 for a touch sensor can be obtained.

The water repellent layer 6 may be formed by a layer made of a cured product of a composition for forming a water repellent layer containing a fluorinated compound or a silicon-containing compound (hereinafter referred to as a water repellent agent (H)).

The fluorinated compound or the silicon-containing compound constituting the water repellent agent (H) may, for example, be a silane coupling agent. The silane coupling agent may be a fluorinated silane coupling agent, a silane coupling agent having an amino group, a silane coupling agent having an acryloyl group, a silane coupling agent having a methacryloyl group, a silane coupling agent having a thiol group, a silane coupling agent having an isocyanate group or a silane coupling agent having an oxiranyl group. Further, commercially available products such as FS-10 (manufactured by Shin-Etsu Chemical Co., Ltd.) may also be used.

The silane coupling agent is preferably a fluorinated silane coupling agent in view of the water repellency and the like, particularly preferably a silane coupling agent having a fluoroalkyl group. The fluoroalkyl group may, for example, be a perfluoroalkyl group or a fluoroalkyl group having a perfluoro(polyoxyalkylene) chain.

A commercially available silane coupling agent having a fluoroalkyl group may, for example, be AQUAPHOBE (registered trademark) CF manufactured by Gelest, Inc., Novec (registered trademark) EGC-1720 manufactured by Sumitomo 3M Limited, OPTOOL (registered trademark) DSX manufactured by Daikin Industries, Ltd. (a silane coupling agent having a perfluoro(polyoxyalkylene) chain).

The silane coupling agent having an amino group may, for example, be aminopropyltriethoxysilane, aminopropylmethyldiethoxysilane, aminoethyl-aminopropyltrimethoxysilane or aminoethyl-aminopropylmethyldimethoxysilane.

The water repellent layer 6 may be formed by applying the composition for forming a water repellent layer containing the above water repellent agent to the upper surface of a stack having the insulating layer 4, followed by heat treatment, or by vapor phase deposition of the water repellent agent on the upper surface of a stack having the insulating layer 4, followed by heat treatment.

In a case where the water repellent layer 6 is formed by applying the composition for forming a water repellent layer, the coating method may, for example, be a spin coating method, a dip coating method, a casting method, a slit coating method or a spray coating method. The heat treatment temperature is preferably from 20 to 150° C., particularly preferably from 70 to 140° C. in view of productivity. The humidity may be controlled at the time of heat treatment so as to increase the reactivity of the water repellent agent.

In a case where the water repellent layer 6 is formed by vapor deposition of the composition for forming a water repellent layer, for example, the solvent is removed from the composition for forming a water repellent layer, the composition is heated to from 250 to 300° C. in a vacuum state, a stack having the insulating layer 4 is put in an atmosphere of the water repellent agent (H) in a vapor state, and such a state is maintained for a predetermined time, whereby gas molecules of the water repellent agent (H) are attached to the surface of the stack, whereby a uniform thin film of the water repellent agent (H) can be formed on the upper surface of the stack.

The front panel 1 for a touch sensor is not limited to the constitutions as shown in FIGS. 2 to 4, and it may have a barrier layer 7 interposed between the transparent substrate 2 and the high resistance layer 3 as shown in FIG. 5 for example.

By interposing the barrier layer 7 between the transparent substrate 2 and the high resistance layer 3, diffusion of the components in the transparent substrate 2 into the high resistance layer 3 can be suppressed, whereby changes in the properties such as the surface resistivity of the high resistance layer 3 can be suppressed. Further, the influences of the surface shape of the transparent substrate 2 such as a glass substrate over the entire front panel 1 for a touch sensor can be suppressed, whereby the shape stability as a whole can be attained.

The barrier layer 7 may, for example, be a layer containing silicon oxide as the main component, or a layer containing silicon oxide and indium oxide as the main components. Among them, a layer containing silicon oxide as the main component is preferred, whereby favorable light transmittance will easily be secured. Further, among layers containing silicon oxide as the main component, a layer which further contains nitrogen, for example, a layer containing silicon oxynitride (SiON) is more preferred, whereby excellent light transmittance can be obtained and in addition, an effect of reducing the luminous reflectance of the front panel 1 for a touch sensor can be obtained.

The barrier layer 7 may be formed on the transparent substrate 2 by sputtering such as DC (direct current) sputtering such as DC (direct current) magnetron sputtering, AC (alternating current) sputtering or RF (radio-frequency) sputtering, in the same manner as formation of the high resistance layer 3.

In a case where the barrier layer 7 is a layer containing silicon oxide as the main component, the target to be used for formation of the barrier layer 7 may be a target containing silicon as the main component. The target containing silicon as the main component may be one consisting solely of silicon, or may be one containing silicon as the main component doped with an element other than silicon, for example, a known dopant such as boron or phosphorus, within a range not to impair the effects of the present invention.

Formation of the barrier layer 7 by sputtering may be carried out by properly adjusting the conditions such as the pressure of the sputtering gas and the film deposition rate, in the same manner as sputtering for the high resistance layer 3.

In a case where a layer containing silicon oxide as the main component and further containing nitrogen, for example, a layer containing silicon oxynitride (SiON) is formed as the barrier layer 7, such a layer may be formed by using, as the sputtering gas, for example, a mixed gas having an oxygen gas and an inert gas mixed with a nitrogen gas or with a mixed gas having a nitrogen atom-containing gas such as N₂O, NO, NO₂ or NH₃.

Formation of such a barrier layer 7 comprising an inorganic oxide such as silicon oxide is not limited to the above sputtering method and may be carried out by a physical vapor deposition method other than the sputtering method, such as a vacuum deposition method, an ion beam assisted deposition method or an ion plating method, or a chemical vapor deposition method such as a plasma CVD method.

The thickness of the barrier layer 7 is preferably at most 100 nm, more preferably at most 50 nm, further preferably at most 30 nm. When the thickness of the barrier layer is at most 100 nm, an appropriate bending strength and a sufficient light transmittance of the entire front panel 1 for a touch sensor will be obtained.

In the front panel 1 for a touch sensor, the refractive index (n) of the barrier layer 7 is preferably from 1.4 to 2.2 with a view to obtaining excellent visible light transmittance and visible light reflectance.

The luminous transmittance of the front panel 1 for a touch sensor is at least 85%. By the luminous transmittance of at least 85%, sufficient visibility will be obtained. The luminous transmittance of the front panel 1 for a touch sensor is more preferably at least 90%.

Further, the luminous reflectance of the front panel 1 for a touch sensor is preferably at most 14%, more preferably at most 2%, further preferably at most 1%.

The static friction coefficient of the front panel 1 for a touch sensor is preferably at most 0.2, more preferably at most 0.15.

Further, the dynamic friction coefficient of the front panel 1 for a touch sensor is preferably at most 0.2, more preferably at most 0.15.

Of the front panel 1 for a touch sensor, the indentation modulus evaluated by a microhardness measurement test is preferably at least 2.5 GPa, more preferably at least 3.0 GPa.

Here, “the microhardness measurement test” is a test method to calculate the hardness from the indentation depth, whereby the indentation modulus (GPa) corresponding to the indentation hardness can be known. This hardness indicates “the hardness” of the front panel 1 for a touch sensor, i.e. the mechanical strength such as the abrasion resistance.

The water contact angle of the front panel 1 for a touch sensor is preferably at least 80°, more preferably at least 90°. The water contact angle is measured by a contact angle meter.

Such a front panel 1 for a touch sensor is to be provided in front of a touch panel main body 5 as shown in FIG. 3 for example, and is so constituted that electricity is applied to transparent electrodes 5a of the touch panel main body 5 from a control unit not shown at a voltage and a frequency controlled in a pattern capable of reproducing the tactile feeling to be expressed, and the electric charge induced on the side of the front panel 1 for a touch sensor is accumulated on the high resistance layer 3, whereby the front panel 1 for a touch sensor is charged. When a sensory receptor X such as a finger is touched to the surface of the front panel 1 for a touch sensor in such a charged state, a weak electrostatic force works between them by means of the insulating layer 4, which is perceived by the sensory receptor X as the sense of touch such as the concave-convex touch feeling.

The transparent electrodes 5a may be provided on the front panel 1 for a touch sensor. That is, the transparent electrodes 5a may be provided on the opposite side of the transparent substrate 2 in the front panel 1 for a touch sensor from a side where the high resistance layer 3 is provided. By such a constitution, the structure of the entire touch panel can be simplified, and in addition, the driving voltage can be suppressed to be low, since the distance between the transparent electrodes 5a and the high resistance layer 3 tends to be short.

The material constituting the transparent electrodes 5a may, for example, be tin-doped indium oxide (ITO), indium/gallium-doped zinc oxide (IGZO) or gallium-doped zinc oxide (GZO). Among them, ITO is preferred, in view of favorable transmittance, resistance stability and durability. The thickness of the transparent electrodes 5a is preferably from 50 to 500 nm, more preferably from 100 to 300 nm. When the thickness is at least 50 nm, a sufficient resistance will be obtained and in addition, the stability of the resistance can be secured. When it is at most 500 nm, a sufficient transmittance can be secured.

In a case where the transparent electrodes 5a are provided on the front panel 1 for a touch sensor, the transparent electrodes 5a are formed by forming a film of a material forming the transparent electrodes 5a on the surface of the transparent substrate 2 opposite to the surface where the high resistance layer 3 is to be provided e.g. by a sputtering method or a deposition method, and forming the film into a pattern of a desired shape e.g. by photolithography or laser patterning.

According to such a front panel 1 for a touch sensor, the surface resistivity of the high resistance layer 3 is from 1 to 100 MΩ/□, whereby the desired sense of touch can be developed with good reproducibility without electrical interaction between the high resistance layer 3 and the transparent electrodes 5a provided on the touch panel main body 5, and thus an excellent touch sensor accuracy will be obtained and in addition, a luminous transmittance of at least 85% will be obtained, whereby excellent visibility will be obtained.

Now, the present invention will be described in detail with reference to Examples. However, it should be understood that the present invention is by no means restricted to such specific Examples.

Examples 1 to 9 are Examples of the present invention, and Example 10 is a Comparative Example.

### <Preparation of Composition for Forming Insulating Layer>

(Preparation of Ultraviolet Curable Resin a1)

Into a 300 mL four-necked flask equipped with a stirrer, 163 g of butyl acetate first grade (manufactured by JUNSEI CHEMICAL CO., LTD.) and 41 g of 2-propanol were put, and 2 g of a reactive ultraviolet absorber (manufactured by Otsuka Chemical Co., Ltd., tradename: R-UVA93), 1 g of a photostabilizer (manufactured by BASF, tradename: TINUVIN292), 0.65 g of a leveling agent (manufactured by BYK Japan K.K., tradename: BYK306), 2.5 g of a photopolymerization initiator (manufactured by BASF, tradename: Irgacure907) and 0.1 g of a polymerization inhibitor hydroquinone monomethyl ether (manufactured by JUNSEI CHEMICAL CO., LTD.) were added thereto and dissolved.

Then, to this solution, 40 g of a multifunctional acrylate (manufactured by Shin-Nakamura Chemical Co., Ltd., tradename: U15HA), 60 g of a polyfunctional acrylate (manufactured by TOAGOSEI CO., LTD., tradename: M325) and 33 g of an acrylic resin (manufactured by MITSUBISHI RAYON CO., LTD., tradename: LR248) were added, stirred and dissolved at room temperature until the solution became uniform, thereby to obtain an ultraviolet curable resin a1 which is a composition for forming an insulating layer.

(Preparation of Ultraviolet Curable Resin a2)

Into a 300 mL four-necked flask equipped with a stirrer, 163 g of butyl acetate first grade (manufactured by JUNSEI CHEMICAL CO., LTD.) and 41 g of 2-propanol were put, and 2 g of a reactive ultraviolet absorber (manufactured by Otsuka Chemical Co., Ltd., tradename: R-UVA93), 1 g of a photostabilizer (manufactured by BASF, tradename: TINUVIN292), 0.65 g of a leveling agent (manufactured by BYK Japan K.K., tradename: BYK306), 2.5 g of a photopolymerization initiator (manufactured by BASF, tradename: Irgacure907) and 0.1 g of a polymerization inhibitor hydroquinone monomethyl ether (manufactured by JUNSEI CHEMICAL CO., LTD.) were added thereto and dissolved.

Then, to this solution, 60 g of a multifunctional acrylate (manufactured by Shin-Nakamura Chemical Co., Ltd., tradename: U15HA), 40 g of a polyfunctional acrylate (manufactured by TOAGOSEI CO., LTD., tradename: M325), 1 g of a fluorinated acrylate (manufactured by Asahi Glass Company, Limited, tradename: C6FMA) and 17 g of an acrylic resin (manufactured by MITSUBISHI RAYON CO., LTD., tradename: LR248) were added, stirred and dissolved at room temperature until the solution became uniform, thereby to obtain an ultraviolet curable resin a2 which is a composition for forming an insulating layer.

(Preparation of Ultraviolet Curable Resin a3)

Into a 300 mL four-necked flask equipped with a stirrer, 122 g of butyl acetate first grade (manufactured by JUNSEI CHEMICAL CO., LTD.) and 31 g of 2-propanol were put, and 0.65 g of a fluorinated surfactant (manufactured by AGC Seimi Chemical Co., Ltd., tradename: Surflon S420) and 2.5 g of a photopolymerization initiator (manufactured by BASF, tradename: Irgacure907) were added thereto and dissolved.

Then, to this solution, 150 g of a multifunctional acrylate (manufactured by Shin-Nakamura Chemical Co., Ltd., tradename: A-DPH) was added, stirred and dissolved at room temperature until the solution became uniform, thereby to obtain an ultraviolet curable resin a3 which is a composition for forming an insulating layer.

(Thermosetting Resin b1)

As a thermosetting composition for forming an insulating layer, a thermosetting silicone hard coating agent (manufactured by Momentive Performance Materials Inc., tradename: PHC587C) was used. Hereinafter, this silicone hard coating agent will be referred to as a thermosetting resin b1.

### Example 1

A glass substrate Q1 (manufactured by Asahi Glass Company, Limited, tradename: AS glass, 100 mm×100 mm×1 mm in thickness) was put in a vacuum chamber, and the vacuum chamber was evacuated until the pressure in the chamber became 1×10⁻⁴ Pa. Then, a film formation treatment was conducted on the glass substrate Q1 under the following conditions to form a high resistance layer A1.

That is, while a mixed gas having 2 vol % of an oxygen gas mixed with an argon gas was introduced, co-sputtering was carried out by a magnetron sputtering method under a pressure of 0.1 Pa using a tin oxide target (manufactured by AGC CERAMICS CO., LTD., tradename: GIT target) and a titanium oxide target (manufactured by AGC CERAMICS CO., LTD., tradename: TXO target).

With the GIT target, pulse sputtering was carried out under conditions of a frequency of 20 kHz, a power density of 3 W/cm² and a reverse pulse width of 5 μsec, and with the TXO target, pulse sputtering was conducted under conditions of a frequency of 20 kHz, a power density of 4 W/cm² and a reverse pulse width of 5 μsec. As a result, a high resistance layer A1 having a thickness of 20 nm was formed on the surface of the glass substrate Q1.

The atomic composition of the high resistance layer A1 was analyzed by ESCA (manufactured by Physical Electronics, Inc., tradename: Quantera SXM) and as a result, the atomic ratio was Sn:Ti=9:1.

Then, on the high resistance layer A1, an adhesion treatment was conducted by the following method.

First, 3-methacryloxypropyltrimethoxysilane (manufactured by Shin-Etsu Chemical Co., Ltd., tradename: KBM503) was diluted to 0.1 mass % with ethanol, about 1 cm³ of the diluted liquid was dropped on the surface of the high resistance layer A1, and the stack was rotated at a number of revolutions of 1,000 rpm for 10 seconds and then at 2,000 rpm for 0.5 second by a spin coater for coating. Then, the stack was put in a constant temperature chamber and maintained at 120° C. for 30 minuets. In such a manner, an adhesion treatment was conducted on the high resistance layer A1.

Then, an insulating layer B1 was formed by the following method.

First, about 1 cm³ of the ultraviolet curable resin a1 was dropped on the surface subjected to the adhesion treatment of the high resistance layer A1, and then the stack was rotated at a number of revolutions of 200 rpm for 10 second and then at 2,000 rpm for 0.5 second by a spin coater to form a coating film. Then, the stack was put and maintained at 120° C. for 10 minutes to dry the coating film.

Then, the stack having a dried coating film formed thereon was irradiated with ultraviolet light by using an UV irradiation apparatus provided with a conveyor (manufactured by USHIO INC., apparatus name: UVC-02516S1) while the transfer rate and the UV intensity were adjusted so that the UV irradiation integrated value became 1,000 mJ/cm² and the peak value became 375 mW/cm², to cure the coating film, thereby to form an insulating layer B1 made of a cured product of the ultraviolet curable resin a1. The thickness of the insulating layer B1 was 10 μm.

In such a manner, a front panel 1 for a touch sensor comprising the high resistance layer A1 and the insulating layer B1 stacked on the glass substrate Q1 was obtained.

### Example 2

In the same manner as in Example 1 except that the ultraviolet curable resin a2 was used instead of the ultraviolet curable resin a1 as the composition for forming an insulating layer, a front panel 2 for a touch sensor comprising a high resistance layer A1 having a thickness of 20 nm and an insulating layer B2 having a thickness of 10 μm stacked on the glass substrate Q1 was obtained.

### Example 3

In the same manner as in Example 1, a high resistance layer A1 was formed on the glass substrate Q1. On the high resistance layer A1, without an adhesion treatment, an insulating layer B3 was formed as follows.

That is, about 1 cm³ of the thermosetting resin b1 was dropped on the high resistance layer A1, and the stack was rotated at a number of revolutions of 200 rpm for 10 seconds and then at 2,000 rpm for 0.5 second by a spin coater, and then put in a constant temperature chamber and maintained at 120° C. for 60 seconds to thermally cure the thermosetting resin b1, thereby to form an insulating layer B3. The thickness of the insulating layer B3 was 5 μm.

In such a manner, a front panel 3 for a touch sensor comprising the high resistance layer A1 and the insulating layer B3 stacked on the glass substrate Q1 was obtained.

### Example 4

The glass substrate Q1 was put in a vacuum chamber, and the vacuum chamber was evacuated until the pressure in the chamber became 1×10⁻⁴ Pa. Then, a film deposition treatment was carried out on the glass substrate Q1 by a magnetron sputtering method under the following conditions to form a barrier layer Ca and a high resistance layer A1 in order.

First, while a mixed gas having 40 vol % of an oxygen gas mixed with an argon gas was introduced, pulse sputtering was carried out by using a Si target under conditions of a pressure of 0.3 Pa, a frequency of 20 kHz, a power density of 3.8 W/cm² and a reverse pulse width of 5 μsec, to form a barrier layer C1 having a thickness of 20 nm comprising silicon oxide on the surface of the glass substrate Q1.

Then, on the barrier layer C1, in the same manner as in Example 1, a high resistance layer A1 having a thickness of 20 nm was formed. In such a manner, by a magnetron sputtering method, a stack comprising the barrier layer C1 and the high resistance layer A1 stacked on the glass substrate Q1 was obtained.

Then, an adhesion treatment was conducted on the high resistance layer A1 of the stack thus obtained in the same manner as in Example 1, and then an insulating layer B2 having a thickness of 10 μm was formed in the same manner as in Example 2 to obtain a front panel 4 for a touch sensor.

### Example 5

In the same manner as in Example 4 except that the ultraviolet curable resin a3 was used instead of the ultraviolet curable resin a1 as the composition for forming an insulating layer, and that the stack was rotated at a number of revolutions of 300 rpm for 10 seconds and then at 2,000 rpm for 0.5 second by a spin coater to form an insulating layer, a front panel 5 for a touch sensor comprising a high resistance layer A1 having a thickness of 20 nm and an insulating layer B5 having a thickness of 10 μm stacked on the glass substrate Q1 was obtained.

### Example 6

On the glass substrate Q1, in the same manner as in Example 4, a barrier layer C1 having a thickness of 20 nm was formed. Then, in the same manner as in Example 1 except that the power density in the pulse sputtering by the GIT target was changed from 3 W/cm² to 3.8 W/cm², co-sputtering was carried out by a magnetron sputtering method. In such a manner, a high resistance layer A2 having a thickness of 20 nm was formed on the barrier layer C1.

The atomic composition of the high resistance layer A2 was analyzed by ESCA (Physical Electronics, Inc., apparatus name: Quantera SXM) and as a result, the atomic ratio was Sn:Ti=9:1.

Then, while a mixed gas having 40 vol % of an oxygen gas mixed with an argon gas was introduced, pulse sputtering was carried out by a magnetron sputtering method using a Si target under conditions of a pressure of 0.3 Pa, a frequency of 20 kHz, a power density of 3.8 W/cm² and a reverse pulse width of 5 μsec to form an insulating layer B4 having a thickness of 100 nm comprising silicon oxide on the high resistance layer A2.

Then, on the insulating layer B4, a water repellent layer D1 was formed by the following method. First, in a crucible as a heating container, 75 g of OPTOOL (registered trademark) DSX (manufactured by Daikin Industries, Ltd.) as a deposition material was put, and the crucible was evacuated by a vacuum pump for at least 10 hours to remove the solvent.

Then, the crucible was heated in the vacuum chamber until the temperature in the crucible reached 270° C. and further maintained for about 10 minutes until the temperature in the crucible was stabilized, and then the stacked substrate comprising the barrier layer C1, the high resistance layer A2 and the insulating layer B4 formed in this order on the glass substrate Q1 was introduced into the vacuum chamber to carry out film formation. In such a manner, a water repellent layer D1 having a thickness of 15 nm was formed on the insulating layer B4, thereby to obtain a front panel 6 for a touch sensor.

### Example 7

The glass substrate Q1 was put in a vacuum chamber, the vacuum chamber was evacuated until the pressure in the chamber became 1×10⁻⁴ Pa, and then a film formation treatment was conducted on the glass substrate Q1 by a magnetron sputtering method under the following conditions to form a barrier layer C2 and a high resistance layer A3 in order.

First, while a mixed gas having 5 vol % of an oxygen gas mixed with an argon gas was introduced, pulse sputtering was carried out by using a target having 30 mass % of silicon oxide mixed with indium oxide, under conditions of a pressure of 0.3 Pa, a frequency of 20 kHz, a power density of 3.8 W/cm² and a reverse pulse width of 5 μsec, to form a barrier layer C2 having a thickness of 70 nm on the surface of the glass substrate Q1.

Then, co-sputtering was carried out by a magnetron sputtering method in the same manner as in Example 1 except that the gas to be introduced into the vacuum chamber was changed from the mixed gas having 2 vol % of an oxygen gas mixed with an argon gas to a mixed gas having 5 vol % of an oxygen gas mixed with an argon gas, and that the power density in the pulse sputtering using the GIT target was changed from 3 W/cm² to 3.8 W/cm². In such a manner, a high resistance layer A3 having a thickness of 100 nm was formed on the barrier layer C2.

The atomic composition of this high resistance layer A3 was analyzed by ESCA (manufactured by Physical Electronics Inc., apparatus name: Quantera SXM) and as a result, the atomic ratio was Sn:Ti=93:7.

Then, on the high resistance layer A3, in the same manner as in Example 5, an insulating layer B4 having a thickness of 90 nm comprising silicon oxide was formed, and on the insulating layer B4, a water repellent layer D1 having a thickness of 15 nm was formed in the same manner as in Example 6. In such a manner, a front panel 8 for a touch sensor comprising the barrier layer C2, the high resistance layer A3, the insulating layer B4 and the water repellent layer D1 stacked in this order on the glass substrate Q1 was obtained.

### Example 8

In the same manner as in Example 6 except that the thickness of the insulating layer was 1 μm, a barrier layer C1 having a thickness of 20 nm, a high resistance layer A2 having a thickness of 20 nm, an insulating layer B4 having a thickness of 1 μm and a water repellent layer D1 having a thickness of 15 nm were stacked in this order on the glass substrate Q1 to obtain a front panel 8 for a touch sensor.

### Example 9

In the same manner as in Example 4 except that a glass substrate Q2 (100 mm×100 mm×0.8 mm in thickness) obtained by subjecting aluminasilicate glass to a chemical tempering treatment was used instead of the glass substrate Q1, a front panel 9 for a touch sensor was obtained.

The glass material for the glass substrate Q2 has a composition comprising, as represented by mol %, 64.5% of SiO₂, 8% of Al₂O₃, 12.5% of Na₂O, 4% of K₂O, 10.5% of MgO, 0.1% of CaO, 0.1% of SrO, 0.1% of BaO and 0.5% of ZrO₂. The chemical tempering treatment was carried out by immersing a glass plate of aluminasilicate glass having the above composition in a KNO₃ molten salt to carry out ion exchange treatment and then cooling the glass plate to the vicinity of room temperature. Of the obtained tempered glass, the surface compressive stress was 735 MPa, and the thickness of the compressive stress layer was 51.2 μm. The surface compressive stress and the thickness of the compressive stress layer were measured by a surface compressive stress meter FSM-6000 (manufactured by Orihara Manufacturing Co., Ltd.).

### Example 10

In the same manner as in Example 6 except that the glass substrate Q2 was used instead of the glass substrate Q1, a front panel 10 for a touch sensor was obtained.

### Example 11

On the glass substrate Q1, in the same manner as in Example 4, a barrier layer C1 having a thickness of 20 nm was formed.

Then, while a mixed gas having 2 vol % of an oxygen gas mixed with an argon gas was introduced, pulse sputtering was carried out by a magnetron sputtering method by using a target having 50 mass % of indium oxide mixed with gallium oxide (manufactured by Sumitomo Metal Mining Co., Ltd., tradename: GIO target) under conditions of a pressure of 0.1 Pa, a frequency of 20 kHz, a power density of 0.8 W/cm² and a reverse pulse width of 5 μsec. As a result, a high resistance layer A4 having a thickness of 15 nm was formed on the surface of the barrier layer C1.

The atomic composition of the high resistance layer A4 was analyzed by ESCA (manufactured by Physical Electronics, Inc., apparatus name: Quantera SXM) and as a result, the atomic ratio was Ga:In=6:4.

Then, on the high resistance layer A4, an adhesion treatment was conducted in the same manner as in Example 1, and then an insulating layer B1 made of a cured 3o product of the ultraviolet curable resin a1 was formed in the same manner as in Example 1, to obtain a front panel 11 for a touch sensor.

Of the front panels 1 to 11 for a touch sensor obtained in Examples 1 to 11, the luminous transmittance, the luminous reflectance, the surface resistivity of the high resistance layer, the indentation modulus, the angle dependence of the reflected color, the static friction coefficient, the dynamic friction coefficient, the water contact angle and the sensitivity of the touch sensor were measured respectively by the following methods. The constitution of the respective layers of the front panels 1 to 11 for a touch sensor is shown in Table 1, and the measurement results are shown in Table 2.

### (Luminous Transmittance)

The spectral transmittance of the front panel for a touch sensor was measured by a spectrophotometer (manufactured by Shimadzu Corporation, apparatus name: SolidSpec-3700), and from the spectral transmittance, the stimulus value Y as specified by JIS Z8701 was calculated, which was regarded as the luminous transmittance.

### (Luminous Reflectance)

The reflectance of the front panel for a touch sensor was measured by a spectrophotometer (manufactured by Shimadzu Corporation, model: UV3150PC), and from the reflectance, the luminous reflectance (the stimulus value Y of reflection as specified by JIS Z8701) was obtained. In order to cancel out the back (side) reflection of the front panel, the rear side of the glass substrate was painted in black to carry out measurement.

### (Surface Resistivity)

After the high resistance layer was formed, the surface resistivity of the high resistance layer was measured by a measuring apparatus (manufactured by Mitsubishi Chemical Analytech Co., Ltd., apparatus name: Hiresta UP (MCP-HT450 model)). A probe was applied to the center of the 10 cm square front panel and electricity was applied at 10 V for 10 seconds for measurement.

### (Indentation Modulus)

The indentation modulus (GPa) of the front panel for a touch sensor was measured by using a microhardness testing machine (manufactured by Fischer Instruments, apparatus name: PICODENTOR HM500) in accordance with ISO14577. For measurement, a Vickers indenter was used.

### (Angle Dependence of Reflected Color)

The rear side of the glass substrate was painted in black to cancel out the back (side) reflection of the front panel, and such a front panel was placed on a table, and a daylight straight tube fluorescent desk lamp (manufactured by NEC Corporation, three wavelength neutral white) was disposed with a height of 40 cm from the table.

Under the light from the fluorescent lamp, the surface of the front panel was visually observed from various angles, and the change in the color tone of the reflected light depending upon the visual observation angle was evaluated.

The angle dependence was evaluated based on standards ∘: the color tone of the front panel surface was monochromatic (mainly blue or the like) when visually observed from any angle, or the change in the color tone was gradual even when the visual observation angle was changed by over 10°, and x: the color tone of the front panel surface was changed when the visual observation angle was changed within a range of at most 10°.

### (Dynamic Friction Coefficient)

The dynamic friction coefficient was measured by using a surface property measuring machine (manufactured by Shinto Scientific Co., Ltd., model: Type 38) under the following conditions.

First, a wiper (manufactured by Asahi Kasei Corporation, tradename: Bencot) was fixed to an indenter (the area of contact with a sample: 10 mm×30 mm), and then the indenter was brought into contact with the front panel placed on a stage of the measuring machine. In a state where a load of 500 g was applied to the indenter, the stage on which the front panel was placed was moved so that the front panel surface was slid five times with a sliding rate of 500 mm/min with a stroke of 20 mm, and the friction was measured by strain gauge at the bottom of the indenter. The average of coefficients of friction calculated from the measured values of the friction and the load applied to the indenter, was regarded as the dynamic friction coefficient.

### (Static Friction Coefficient)

Using the same apparatus for measurement of the dynamic friction coefficient except that the indenter used for measurement of the dynamic friction coefficient was changed to an iron ball, the front panel surface was slid under the same conditions, and the friction coefficient calculated from the friction measured when the iron ball started to slide was regarded as the static friction coefficient.

### (Water Contact Angle)

About 1 μL of a pure water droplet was placed on the surface of the front panel for a touch sensor, and the water contact angle was measured by a contact angle meter (manufactured by Kyowa Interface Science Co., Ltd., apparatus name: DM-051).

### (Sensitivity of Touch Sensor)

A copper conductive tape was bonded to four sides on the rear side of each of the front panels 1 to 11 for a touch sensor, and a voltage of 2 kV was applied at a frequency of about 400 Hz.

The surface of each of the front panels 1 to 11 for a touch sensor to which electricity was applied, was traced with a fingertip, and touch sensor sensitivity was evaluated by the level of the sense of touch perceived by the fingertip. In Table 2, ∘ represents that the sense of touch was clearly perceived by the fingertip, and x represents that no sense of touch was perceived by the fingertip, or even if perceived, it was very weak, or the sense of touch perceived by the fingertip was so intense that the fingertip was excessively stimulated, and no appropriate sensor sensitivity was obtained.

The sensor sensitivity was evaluated at an applied voltage of 2 kV, since when the voltage was supplied with an applied voltage within a range of from 750 V to 100 kV to a sample having a PET film with a thickness of 10 μm bonded to a copper film, the sense of touch appeared at about 2 kV.

TABLE 1

| | High resistance layer | | Barrier layer | | Insulating layer | | Water repellent layer | |
|---|---|---|---|---|---|---|---|---|
| | | | Layer | | | | | |
| | | Thickness | constitution | Thickness | Layer constitution | Thickness | Layer | Thickness |
| | Layer constitution (target) | [nm] | (target) | [nm] | (constituting material) | [nm] | constitution | [nm] |
| Ex. 1 | A1 | 20 | — | — | B1 | 10 | — | — |
| | (Tin oxide/titanium oxide) | | | | (Ultraviolet curable resin a1) | | | |
| Ex. 2 | A1 | 20 | — | — | B2 | 10 | — | — |
| | (Tin oxide/titanium oxide) | | | | (Ultraviolet curable resin a2) | | | |
| Ex. 3 | A1 | 20 | — | — | B3 | 5 | — | — |
| | (Tin oxide/titanium oxide) | | | | (Thermosetting resin b1) | | | |
| Ex. 4 | A1 | 20 | C1 | 20 | B2 | 10 | — | — |
| | (Tin oxide/titanium oxide) | | (Si target) | | (Ultraviolet curable resin a2) | | | |
| Ex. 5 | A1 | 20 | C1 | 20 | B5 | 10 | — | — |
| | (Tin oxide/titanium oxide) | | (Si target) | | (Ultraviolet curable resin a3) | | | |
| Ex. 6 | A2 | 20 | C1 | 20 | B4 | 0.1 | D1 | 15 |
| | (Tin oxide/titanium oxide) | | (Si target) | | (Si target) | | | |
| Ex. 7 | A3 | 100 | C2 | 70 | B4 | 0.09 | D1 | 15 |
| | (Tin oxide/titanium oxide) | | (Indium oxide/ | | (Si target) | | | |
| | | | silicon oxide) | | | | | |
| Ex. 8 | A2 | 20 | C1 | 20 | B4 | 1 | D1 | 15 |
| | (Tin oxide/titanium oxide) | | (Si target) | | (Si target) | | | |
| Ex. 9 | A1 | 20 | C1 | 20 | B2 | 10 | — | — |
| | (Tin oxide/titanium oxide) | | (Si target) | | (Ultraviolet curable resin a2) | | | |
| Ex. 10 | A2 | 20 | C1 | 20 | B4 | 0.1 | D1 | 15 |
| | (Tin oxide/titanium oxide) | | (Si target) | | (Si target) | | | |
| Ex. 11 | A4 | 15 | C1 | 20 | B1 | 10 | — | — |
| | (Gallium oxide/indium oxide) | | (Si target) | | (Ultraviolet curable resin a1) | | | |

TABLE 2

| | | | | | | Angle | | | Water |
|---|---|---|---|---|---|---|---|---|---|
| | Luminous | Luminous | Surface | Touch | Indentation | dependence | Static | Dynamic | contact |
| | transmittance | reflectance | resistivity | sensor | modulus | of reflected | friction | friction | angle |
| | [%] | [%] | [MΩ/□] | sensitivity | [GPa] | color | coefficient | coefficient | [°] |
| Ex. 1 | 90 | 7 | 50 | ∘ | 3.8 | ∘ | 0.10 | 0.09 | 90 |
| Ex. 2 | 90 | 7 | 50 | ∘ | 3.8 | ∘ | 0.13 | 0.09 | 92 |
| Ex. 3 | 90 | 7 | 50 | ∘ | 4.5 | ∘ | 0.13 | 0.09 | 91 |
| Ex. 4 | 90 | 7 | 48 | ∘ | 3.8 | ∘ | 0.13 | 0.09 | 90 |
| Ex. 5 | 90 | 7 | 48 | ∘ | 3.8 | ∘ | 0.11 | 0.09 | 90 |
| Ex. 6 | 94 | 0.5 | 48 | ∘ | 55.8 | ∘ | 0.13 | 0.07 | 112 |
| Ex. 7 | — *₁ | — | — | — | — | — | — | — | — |
| Ex. 8 | 90 | 7 | 48 | ∘ | 55.8 | x | 0.13 | 0.07 | 110 |
| Ex. 9 | 90 | 7 | 48 | ∘ | 55.8 | ∘ | 0.25 | 0.18 | 20 |
| Ex. 10 | 94 | 0.5 | 48 | ∘ | 55.8 | ∘ | 0.13 | 0.07 | 112 |
| Ex. 11 | 80 | 15 | 0.7 | x | 3.8 | ∘ | 0.13 | 0.09 | 110 |

(*₁ ″—″: no evaluation results obtained.)

As evident from Table 2, in Examples 1 to 10, the high resistance layer had a surface resistivity of from 1 to 100 MΩ/□, whereby a favorable sensor sensitivity was obtained, and the luminous transmittance was at least 85% and the luminous reflectance was at most 7%, whereby excellent visibility was obtained.

Whereas, in Example 11, the surface resistivity was 0.7Ω/□, whereby the sense of touch perceived by the fingertip was excessively high, and no appropriate sensor sensitivity was obtained, and further, the luminous transmittance was less than 85% and the luminous reflectance exceeded 7%, whereby the visibility was poor.

The entire disclosure of Japanese Patent Application No. 2011-283808 filed on Dec. 26, 2011 including specification, claims, drawings and summary is incorporated herein by reference in its entirety.

1. A touch panel interface device comprising:
a display screen; and
a touch sensor with a front panel that is positioned to be touchable by a body member and that comprises:
a transparent conductive electrode;
a transparent insulating layer;
a transparent substrate between the transparent conductive electrode and the transparent insulating layer; and
a high resistance layer between the transparent substrate and the transparent insulating layer and having a surface resistivity that is between 1 and 100 MΩ/□;
the front panel having a luminous transmittance that is at least 80% of light from the display screen.

2. The touch panel interface device of claim 1, wherein the front panel that is touchable by the body member has a touchable exterior surface with a static friction coefficient that is at most 0.2.

3. The touch panel interface device of claim 1, wherein the front panel that is positioned to be touchable by the body member has a touchable exterior surface with a dynamic friction coefficient that is at most 0.2.

4. The touch panel interface device of claim 1, wherein the front panel that is positioned to be touchable by the body member has an indentation modulus of at least 2.5 GPa.

5. The touch panel interface device of claim 1, wherein the front panel that is positioned to be touchable by the body member has a luminous transmittance that is at least 85%.

6. The touch panel interface device of claim 1, wherein the front panel that is positioned to be touchable by the body member has a luminous reflectance that is at most 2%.

7. The touch panel interface device of claim 1, wherein the front panel that is positioned to be touchable by the body member has a touchable exterior surface with a water contact angle that is at least 80°.

8. The touch panel interface device of claim 7, wherein the touchable exterior surface of the front panel includes an outer surface of the transparent insulating layer, and the outer surface of the transparent insulating layer has the water contact angle that is at least 80°.

9. The touch panel interface device of claim 8, wherein the transparent insulating layer with the water contact angle that is at least 80° includes a fluorinated polymerizable monomer.

10. The touch panel interface device of claim 9, wherein the fluorinated polymerizable monomer in the transparent insulating layer of the front panel is at least one of perfluorohexylethyl (meth)acrylate or perfluorobutylethyl (meth)acrylate.

11. The touch panel interface device of claim 9, wherein the fluorinated polymerizable monomer in the transparent insulating layer of the front panel is represented by:
CH₂═C(R⁶)COOX³R^{f}
wherein R⁶ is a hydrogen atom, a methyl group, or a trifluoromethyl group,
X³ is a C₁₋₆ bivalent organic group, and
R^{f} is a C₄₋₆ perfluoroalkyl group.

12. The touch panel interface device of claim 7, wherein:
the front panel further comprises a water repellent layer that is separated from the high resistance layer by the transparent insulating layer, and
the touchable exterior surface of the front panel is an outer surface of the water repellent layer, and the outer surface of the water repellent layer has the water contact angle that is at least 80°.

13. The touch panel interface device of claim 12, wherein the transparent insulating layer in the front panel contains no fluorinated polymerizable monomers.

14. The touch panel interface device of claim 13, wherein the transparent insulating layer in the front panel is devoid of perfluorohexylethyl (meth)acrylate and devoid of perfluorobutylethyl (meth)acrylate.

15. The touch panel interface device of claim 1, wherein the transparent conductive electrode in the front panel has a thickness that is between 50 and 500 nm.

16. The touch panel interface device of claim 15, wherein the thickness of the transparent conductive electrode in the front panel is between 100 and 300 nm.

17. The touch panel interface device of claim 1, wherein the high resistance layer in the front panel has a refractive index that is between 1.8 and 2.5.

18. The touch panel interface device of claim 1, wherein the high resistance layer in the front panel has a thickness that is between 5 and 100 nm.

19. The touch panel interface device of claim 18, wherein the thickness of the high resistance layer in the front panel is between 5 and 30 nm.

20. The touch panel interface device of claim 1, wherein the high resistance layer in the front panel includes titanium oxide.

21. The touch panel interface device of claim 1, wherein the transparent insulating layer in the front panel has a refractive index that is between 1.3 and 1.8.

22. The touch panel interface device of claim 1, wherein the transparent insulating layer in the front panel has a volume resistivity that is at least 10¹⁰ Ω·cm.

23. The touch panel interface device of claim 1, wherein the transparent insulating layer in the front panel includes a cured product of an ultraviolet-curable acrylate composition.

24. The touch panel interface device of claim 1, wherein the front panel further comprises a barrier layer of silicon oxynitride between the transparent substrate and the high resistance layer.

25. The touch panel interface device of claim 1, wherein the front panel further comprises an adhesion layer including 3-methacryloxypropyltrimethoxysilane applied to the high resistance layer.

26. An apparatus comprising:
means for producing a front panel for a touch sensor by:
providing a transparent conductive electrode and a high resistance layer on opposing sides of a transparent substrate, the high resistance layer having a surface resistivity that is between 1 and 100 MΩ/□; and
forming a transparent insulating layer on the high resistance layer, the produced front panel having a luminous transmittance that is at least 80%.
